(19) United States
(12) Patent Application Publication
(10) Pub. No.: US 2009/0292589 A1
(43) Pub. Date: Nov. 26, 2009

(54) Systems and Methods for Sales Tracking, Accountability, and Reporting

(75) Inventors: Lawrence J. Marsh, Scottsdale, AZ (US); John M. Wepler, Hudson, OH (US); Patrick T. Linnert, Concord, OH (US); Andrew C. Roberts, Perry, OH (US); Michael E. Branstein, Prospect, KY (US)

Correspondence Address: EDWARDS ANGELL PALMER & DODGE LLP, P.O. BOX 55874, BOSTON, MA, 02205, US

(73) Assignee: Marsh, Berry & Company, Inc.

(21) Appl. No.: 12/471,320

(22) Filed: May 22, 2009

Related U.S. Application Data
(60) Provisional application No. 61/055,377, filed on May 22, 2008.

(51) Int. Cl. G06Q 10/00; G06Q 40/00; G06F 17/30

(52) U.S. Cl. 705/10; 705/7; 705/30; 705/11; 707/104.1

(57) ABSTRACT

A system for tracking and managing sales performance of producers within an insurance agency. The system includes a database housing sales information for the agency, a sales management server interfacing with the database, a display device connected to the sales management server, a user interface module running on the sales management server and being configured to receive input from a user and to display content from the database on the display device, and an interactive sales pipeline module forming part of the user interface module. The interactive sale pipeline module is configured to receive input from a user and store the information in the database and to display a grid of sales process information including information regarding an initial appointment stage, a marketing submission stage, and a proposal delivery stage.

### CROSS REFERENCE TO RELATED APPLICATION

This application claims priority to U.S. Provisional Patent Application No. 61/055,377, filed May 22, 2008, the entire disclosure of which is herein incorporated by reference. This application is related to an application titled “Methods and System for Service Tracking and Timeline Updating”, which is jointly owned and was filed in the U.S. Patent and Trademark Office concurrently with the present application. The entire disclosure of the above mentioned application is also incorporated herein by reference.

### COPYRIGHT NOTICE

Portions of the disclosure of this patent document, including the drawings, contain material which is subject to copyright protection. The copyright owner has no objection to the reproduction of the patent document or the patent disclosure, as it appears in the records and files of the U.S. Patent and Trademark Office, but otherwise reserves all copyrights whatsoever.

### BACKGROUND OF THE INVENTION

1. Field of the Invention

The present invention relates to a system for tracking prospective sales and results. More particularly, the present invention is directed to a web-based sales tracking, accountability, and results technology platform that is particularly well-suited for insurance professionals.

2. Description of Related Art

One of the most pressing challenges facing insurance distributors today is creating a new business production machine to drive organic growth. Organic growth is defined as the process of business expansion due to increased output sales, or both, rather than growth through external means such as acquisitions or take-overs. Organic growth involves leveraging the resources already available to an organization to maximize profitability and thus the success of the organization.

For insurance distributors, maximizing organic growth is essential to successfully competing in a competitive marketplace. Growth is directly correlated to value and sustainability. Growth provides the opportunity to maximize reinvestment dollars for people, process, technology, and value added differentiation platforms. Those taking advantage of organic growth opportunities will continue to realize revenue and earnings growth, which is necessary to fund perpetuation at a fair price, position an organization for long term stability, and create a desirable investment option for current or future stockholders in the organization.

Maximizing organic growth for an insurance agency means maximizing the productivity of the agency's producers. The key to maximizing producer productivity is having enough pertinent information to make strategic decisions regarding the agency's resources and personnel. Consequently, there is a compelling need for an integrated, robust technology platform for creating, tracking, managing, and auditing sales results and prospects for each producer within an agency and for the agency as a whole. Accordingly, the present invention is directed to a system and methods of producer pipeline management that meets these needs.

### SUMMARY OF THE INVENTION

Advantages of the present invention will be set forth in and become apparent from the description that follows. Additional advantages of the invention will be realized and attained by the methods and systems particularly pointed out in the written description and claims, as well as from the appended drawings.

To achieve these and other advantages and in accordance with the purpose of the invention, as embodied herein, the invention includes a system for tracking and managing sales performance of producers within an insurance agency. The system includes a database housing sales information for the agency, a sales management server interfacing with the database, a display device connected to the sales management server, a user interface module running on the sales management server and being configured to receive input from a user and to display content from the database on the display device, and an interactive sales pipeline module forming part of the user interface module. The interactive sale pipeline module is configured to receive input from a user and store the information in the database and to display a grid of sales process information including information regarding an initial appointment stage, a marketing submission stage, and a proposal delivery stage.

A method for tracking and managing sales performance of producers within an insurance agency is also provided. The method includes the steps of creating an opportunity account within a secure web-based interface; populating a database with data regarding the opportunity account using an interactive sales pipeline module within the web-based interface; displaying the data in the interactive sales pipeline module; automatically generating an opportunity reports from the data entered into the interactive sales pipeline module in the web-based interface; and allowing an authorized user to view the opportunity reports.

It is to be understood that the foregoing general description and the following detailed description are exemplary and are intended to provide further explanation of the invention claimed. The accompanying drawings, which are incorporated in and constitute part of this specification, are included to illustrate and provide a further understanding of the method and system of the invention. Together with the description, the drawings serve to explain principles of the invention.

### BRIEF DESCRIPTION OF THE DRAWINGS

FIG. 1 is a schematic view of a system for sales tracking, accountability, and reporting of the present invention.

FIG. 2 illustrates a Login page allowing a user to securely access the system of the present invention.

FIG. 3 illustrates a home page of the user interface that forms a part of the system of the present invention.

FIG. 4 illustrates a Sales Center menu on the home page of the user interface that forms a part of the system of the present invention.

FIG. 5 illustrates a Pipeline page of the user interface that forms a part of the system of the present invention.

FIG. 6 illustrates an Add Opportunity window on top of the Pipeline page shown in FIG. 5.

FIG. 7 illustrates a floating pipeline editing window on top of the Pipeline page shown in FIG. 5.

FIG. 8 illustrates an Account Center page of the user interface that forms a part of the system of the present invention.

FIG. 9 illustrates a Pipeline Reports page of the user interface that forms a part of the system of the present invention.

FIG. 10 illustrates a Pipeline Commission Summary page of the user interface that forms a part of the system of the present invention.

FIG. 11 illustrates a Pipeline Opportunity Summary page of the user interface that forms a part of the system of the present invention.

FIG. 12 illustrates a Pipeline Ratios page of the user interface that forms a part of the system of the present invention.

FIG. 13 illustrates a Pipeline Commission Projection page of the user interface that forms a part of the system of the present invention.

FIG. 14 illustrates a Pipeline Need By Summary page of the user interface that forms a part of the system of the present invention.

FIG. 15 illustrates a Pipeline Missing Information Summary page of the user interface that forms a part of the system of the present invention.

FIG. 16 illustrates a Pipeline Agency Summary page of the user interface that forms a part of the system of the present invention.

FIG. 17 illustrates a Closed Business Reports page of the user interface that forms a part of the system of the present invention.

FIG. 18 illustrates a Closed Business Commission Summary page of the user interface that forms a part of the system of the present invention.

FIG. 19 illustrates a Closed Business Opportunity Summary page of the user interface that forms a part of the system of the present invention.

FIG. 20 illustrates a Closed Business Ratios page of the user interface that forms a part of the system of the present invention.

FIG. 21 illustrates a Closed Business Details by Producer page of the user interface that forms a part of the system of the present invention.

FIG. 22 illustrates a Closed Business Agency Summary page of the user interface that forms a part of the system of the present invention.

FIG. 23 illustrates a Validation Reports page of the user interface that forms a part of the system of the present invention.

FIG. 24 illustrates a Validation Appointments by Date page of the user interface that forms a part of the system of the present invention.

FIG. 25 illustrates a Validation Commission Summary page of the user interface that forms a part of the system of the present invention.

FIG. 26 illustrates a Validation Appointment Summary page of the user interface that forms a part of the system of the present invention.

FIG. 27 illustrates a Validation Commission Projection page of the user interface that forms a part of the system of the present invention.

FIG. 28 illustrates a Lost Business Reports page of the user interface that forms a part of the system of the present invention.

FIG. 29 illustrates a Lost Business Walk Aways by Producers page of the user interface that forms a part of the system of the present invention.

FIG. 30 illustrates a Lost Business Expirations by Producer page of the user interface that forms a part of the system of the present invention.

FIG. 31 illustrates a Carrier Summary page of the user interface that forms a part of the system of the present invention.

FIG. 32 illustrates a Referral Summary page of the user interface that forms a part of the system of the present invention.

FIG. 33 illustrates a Weekly Status Details page of the user interface that forms a part of the system of the present invention.

FIG. 34 illustrates an Account Summary page of the user interface that forms a part of the system of the present invention.

### DETAILED DESCRIPTION OF PREFERRED EMBODIMENTS

Reference will now be made in detail to the present preferred embodiments of the sales tracking, accountability, and reporting system and methods, examples of which are illustrated in the accompanying drawings.

The present invention includes a technology platform that allows insurance professionals such as agents and brokers to more effectively manage the new business sales pipeline, increase retention, and maximize organic growth. Organic growth is defined as the process of business expansion due to increased output and/or sales from an the existing business of an organization. Although this specification makes reference to insurance agents/brokers and insurance agencies, it should be understood that the systems and methods of the present invention are also applicable to a wide variety of other businesses and organizations as well.

The system provides insurance agents and brokers with a common organizational platform for agency personnel to manage the new business pipeline, while maintaining the flexibility to collaborate with peers by sharing strategic sales activities, target dates, and milestones. The system includes producer pipeline management tool that allows producers and respective service team members to easily track the status of any prospect through the sales cycle, from the initial appointment, to carrier submissions, client proposals, and end results. The system provides a centralized platform to proactively measure, monitor, and drive sales activities. The system also includes benchmarking capabilities, allowing a user to view past sales performance of the user's organization relative to other organizations within the same industry, and to identify areas where improvement can have a significant impact. In one exemplary embodiment, a benchmarking report may be produced comparing both individual and agency performance against industry averages in the areas of sales management, prospect management, account management, and individual producer results.

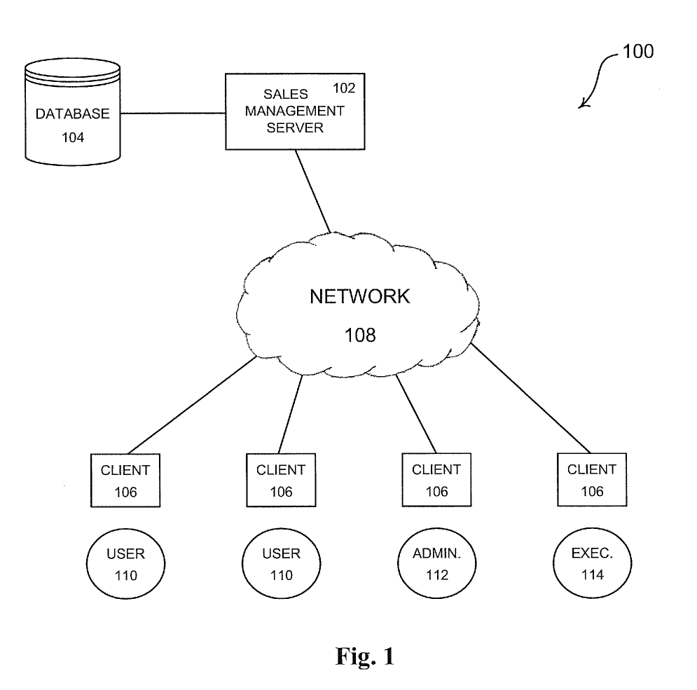

For purposes of explanation and illustration, and not limitation, an exemplary embodiment of a system in accordance with the present invention is shown in FIG. 1 and s designated generally by the reference numeral 100. System 100 includes a sales management server computer 102, a database 104, and a plurality of client devices 106. Database 104, sales management server 102, and client devices 106 may interface with one another via a network 108. Network 108 may be any suitable network, including a company intranet or other local area network, a wide area network, and the Internet. Server 102 may include a plurality of servers, and database 104 may include a plurality of databases. Client devices may include a computer, a mobile phone, or any other network-enabled device.

System 100 may comprise software components running on either sales management server 102 or clients 106. Server 102 and clients 106 may run any suitable operating system and may include a variety of hardware configurations. Both sales management server 102 and clients 106 may include a processor coupled to a memory module and to a mass storage device via a bus or other communication medium; a display or other output device interfacing with the processor; and a keyboard, mouse, touchpad, or other input device that receives input from a user and interfaces with the processor. In one exemplary embodiment, clients 106 each include an input device for receiving user input and a display device for displaying content. The software implementing system 100 may include instructions written in a high level computer language and stored in a mass storage device. In one exemplary embodiment, a plurality of modules having distinct functions run on sales management server 102.

System 100 is preferably a permission-based system. That is, access to different parts of the system is based on the permission level granted to each individual user. In one exemplary embodiment, access to database 104 is provided through a secure web-based software application running on sales management server 102. Through client devices 106, individual users with different permission levels may be granted access to portions of system 100. For example, system 100 may grant certain access permissions to a user 110, who may be an agent, broker, or other producer within an insurance agency. User 110 may have the ability to create, update, and modify the user's sales pipeline and view individual reports, for example, but may not have permission to edit or view other producer pipelines and reports. User 110 may be granted access to only those pipelines and reports that fall under the responsibility of the user, or the user may be granted permission to access all agency information. System 100 may grant additional access permissions to an administrator 112. Administrator 112 may have permission to add, modify, and delete information in the system. Administrator 112 may also be able to perform a variety of administrative functions that will not be available to user 110. System 100 may also grant a different set of permissions to an executive user 114. Executive user 114 may have permission to view data and reports relating to the entire agency, but may not have permission to perform administrative tasks within system 100. In one exemplary embodiment, users 110 will have the option of sharing their sales data with other producers in the same agency.

In one exemplary embodiment, sales management server 102 requires authentication from user 110 prior to allowing access to system 100. Upon receiving a request from a web browser, server 102 may require user 110 to login by entering a user name and password. However, the step of authentication could also be accomplished by other suitable means. Once server 102 has determined that user 110 is an authorized user, user 110 will be granted access to system 100. In one exemplary embodiment, user 110 is an individual insurance agent or broker. Administrator 112 and executive user 114 are authenticated and granted access to software application 106 in a similar manner.

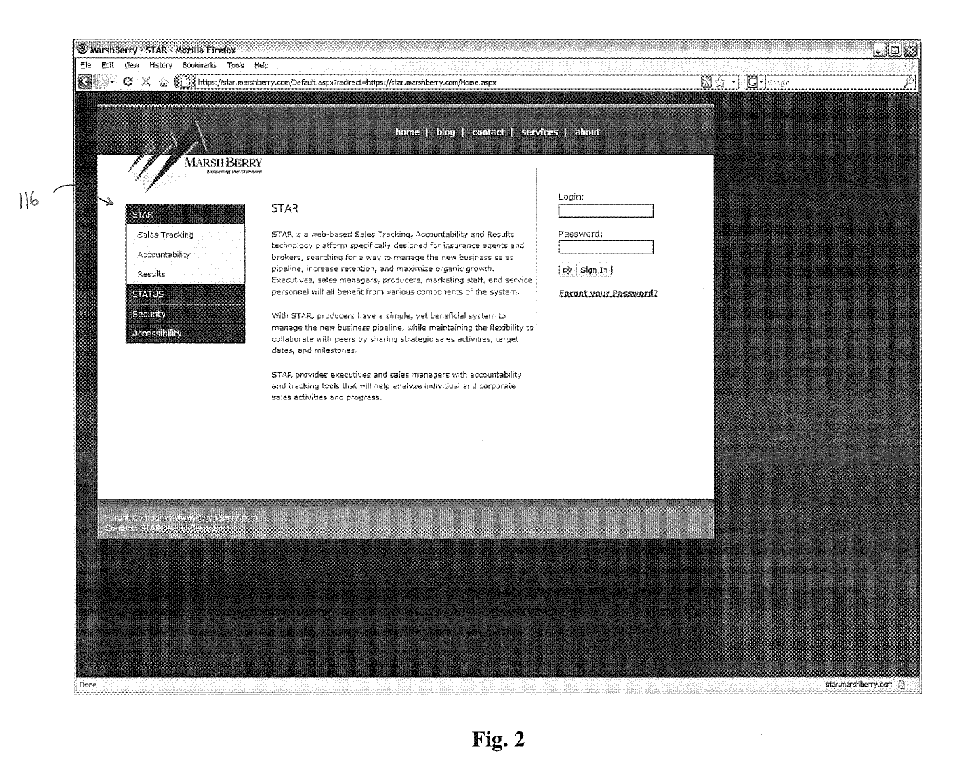

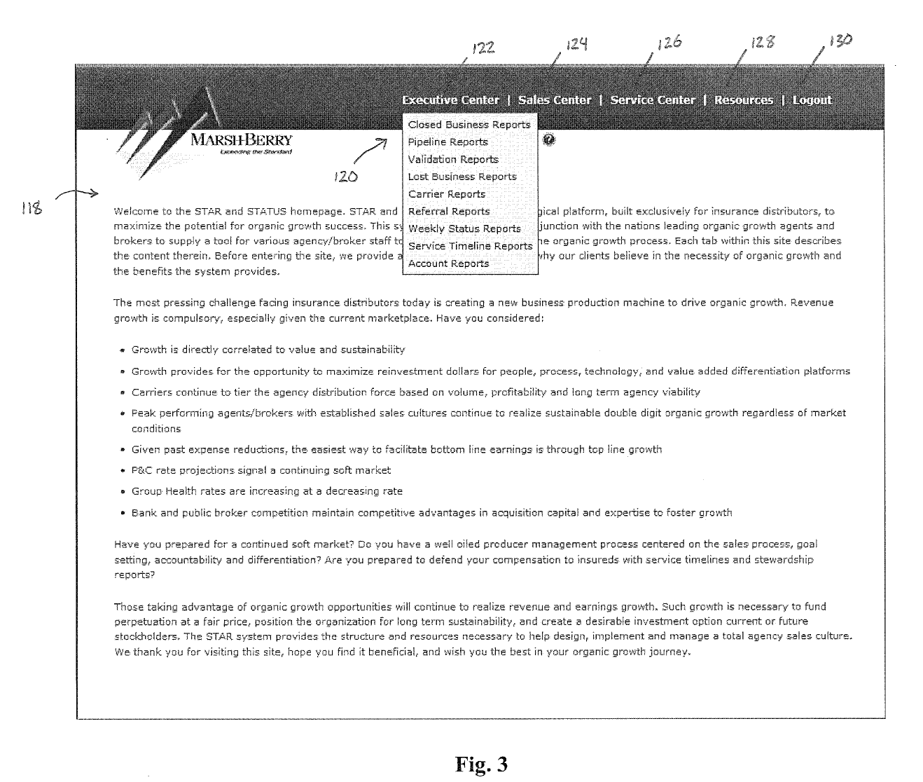

FIG. 2 illustrates an exemplary portion of a graphical user interface 116 providing access to system 100 through a login page within a web browser. Once sales management server 102 has authenticated user 110, user 110 will be have access to a homepage 118, as shown in FIG. 3. Homepage 118 includes a plurality of links or buttons 120 that may be selected by the user. In the exemplary embodiment shown in FIG. 2, links 120 include an Executive Center link 122, a Sales Center link 124, a Service Center link 126, a Resources link 128, and a Logout link 130. In one exemplary embodiment, links 120 are available in the same location on each page that is presented to user 110, thus facilitating navigation of user interface 116.

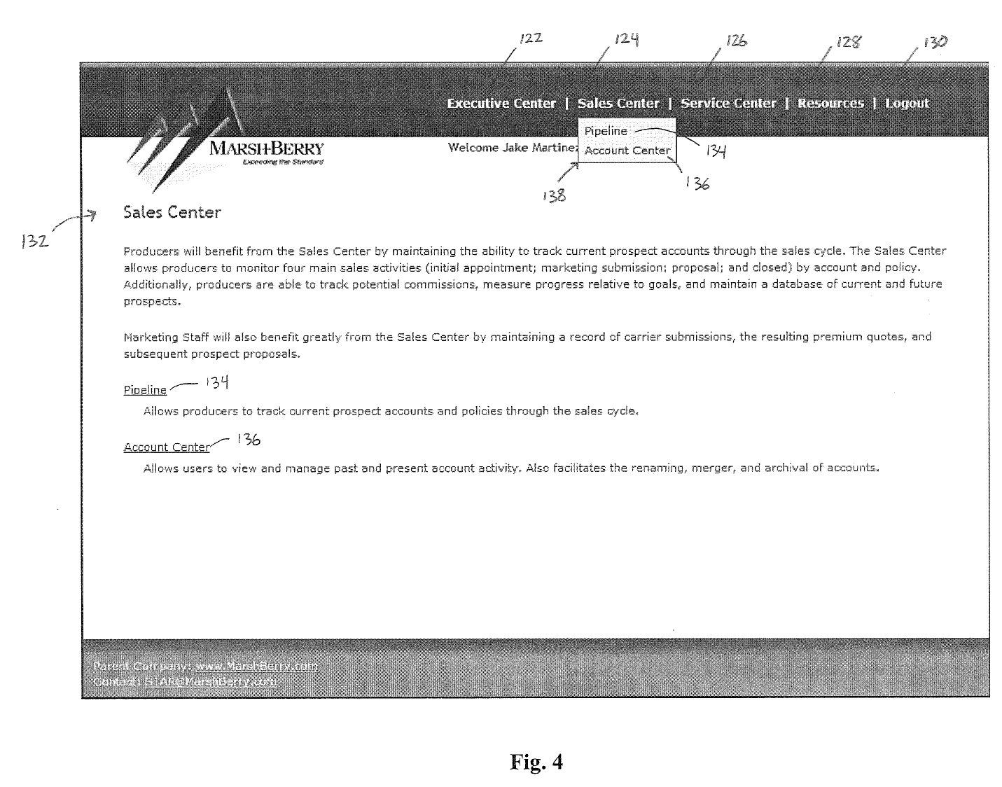

As shown in FIG. 4, interface 116 includes a sales center. The sales center allows users to track current prospect accounts through the sales cycle. The sales center allows user 110 to track and manage opportunities for new sales. An opportunity may be with an existing client or may be with a prospective client. The sales center also allows users to monitor sales activities, including the initial appointment to discuss the opportunity with the client or prospective client, marketing submissions relating to the opportunity, proposals regarding the opportunity made to the client, and the closing of the opportunity. System 100 allows the user to monitor these sales activities by account and policy, and also allows users to track potential commissions, measure progress relative to goals, and maintain an up-to-date listing of current and future prospects. The sales center is accessed by clicking or otherwise selecting Sales Center link 124, which will call up a Sales Center homepage 132 that provides access to a Pipeline link 134 and an Account Center link 136. Alternately, a Sales Center menu 138 may also be accessed from within any page of user interface 116 by hovering over Sales Center link 124.

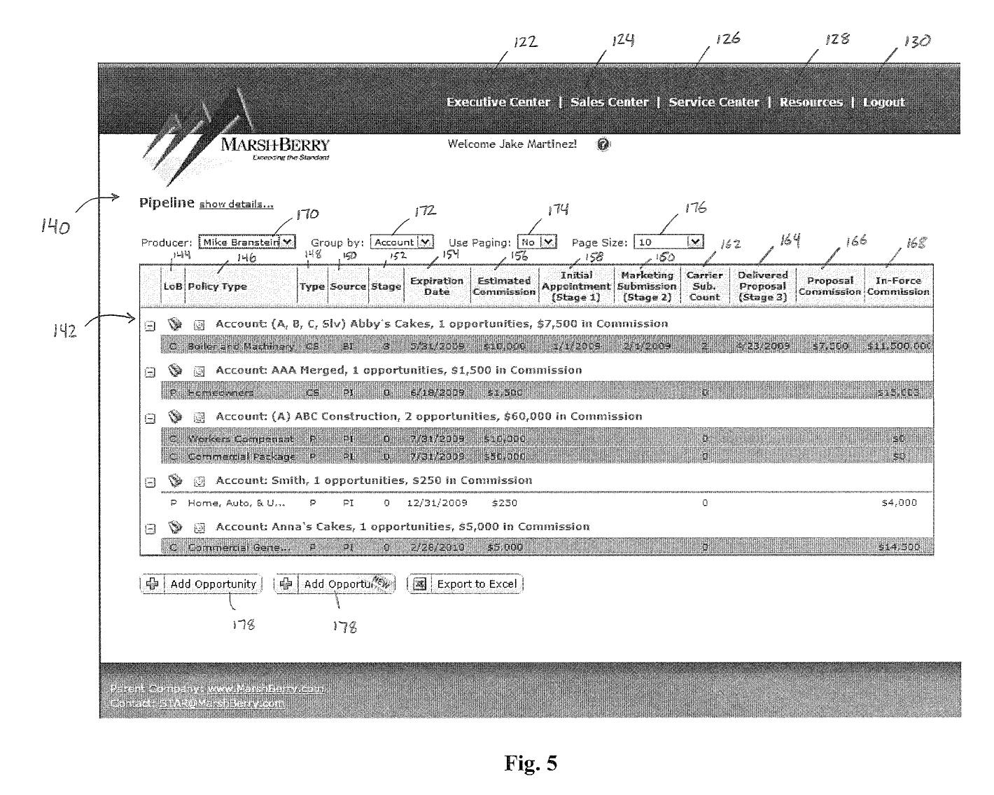

A Pipeline page 140, as shown in FIG. 5, is accessed by clicking or otherwise selecting Pipeline link 134. Pipeline page 140 provides an electronic sales pipeline tracking interface, allowing users to track current prospect accounts through each stage of the sales process, including the identification of opportunity stage, the initial appointment stage, the marketing submission stage, the proposal delivery stage, and the closing stage. Pipeline page 140 includes an interactive pipeline grid 142 that allows a user to quickly view and change the status of all outstanding business opportunities. Pipeline grid 142 may display a wide variety of information about an opportunity under one or more columns, including columns for the opportunity's line of business (LoB) 144, policy type 146, opportunity type 148, source 150, stage 152, expiration date 154, estimated commission 156, initial appointment 158, marketing submission 160, carrier submission count 162, delivered proposal 164, proposal commission 166, and in-force commission 168. Pipeline grid 142 may include information relating to one or opportunities under each of the column headings.

Line of business column 144 indicates the opportunity's line of business, and may include options such as commercial, personal, group benefits, individual life and health, bond, and small commercial, among others. In one exemplary embodiment, interface 116 may include a drop-down menu allowing the user to choose from a pre-populated list designating the opportunity's line of business. In another exemplary embodiment, user 110 may be able to enter any line of business into an editable text field.

Policy type column 146 indicates the opportunity's policy type. In one exemplary embodiment, available policy types will be set by administrator 112 and may include a plurality of policy types for each of the available lines of business. After user 110 selects a line of business, a policy type field may be automatically updated to display available policy types for the selected line of business. Exemplary policy types include worker's compensation, boiler and machinery, commercial packaging, and home and auto, among others.

Opportunity type column 148 shows the automatic classification of the opportunity within system 100. Opportunities are classified based upon two factors: whether the opportunity involves a new prospect or an existing client and whether the opportunity is considered career or peripheral. Prospects are accounts that have no existing policies written with the agency of user 110. By definition, an account can only be considered a prospect once. After the initial round of policies has been written for an account, the account is then considered a customer, rather than a new prospect. Existing clients are termed customers within system 100. First-time prospect opportunities, that is, opportunities relating to new prospective clients are classified as “prospecting” opportunity types, and are designated by the abbreviation “P” in the opportunity type column 148 within pipeline grid 142. Existing customer opportunities are classified as “cross selling” opportunity types or “rounding” opportunity types. Cross selling opportunities are opportunities for which user 110 is selling business across or to a different line of business than what has previously been sold to an existing customer. Cross selling opportunities are designated by the abbreviation “CS” in the opportunity type column 148 within pipeline grid 142. Rounding opportunities are those opportunities in which a producer is selling business within an existing line of business for an existing customer and are designated with the abbreviation “R” in the opportunity type column 148 in the pipeline grid 142.

Source column 148 in pipeline grid 142 indicates how user 110 located the opportunity. In one exemplary embodiment, options for populating the column under source column 148 include Bank Initiated, when the agency of user 110 is owned by a bank and the opportunity was a bank referral; Leveraged Introduction, when user 110 leverages their relationship with an existing client to gain access to a new prospect; Producer Initiated, when user 110 gains the opportunity via cold call, marketing campaign, door-to-door introduction, or the like; Prospect Initiated, when the prospect or existing client contacts user 110 or the user's agency regarding a new opportunity; Reactive Referral, when user 110 reacts to a referral from within the agency to gain an opportunity; and Telemarketing, when a new opportunity is gained via a telemarketing firm contracted by the user's agency. Each of these indications of source may be abbreviated when shown in source column 148 in pipeline grid 142.

Stage column 150 in pipeline grid 142 indicates the current stage of the opportunity, designated as stage 0, stage 1, stage 2, stage 3, or stage 4. Stage 0 is the beginning stage for all opportunities tracking within pipeline grid 142. Immediately after being entered, an opportunity is assigned a stage of 0, which represents the beginning of the sales process.

Stage 1 is the initial appointment stage, which begins when a date is entered in stage column 150 in pipeline grid 142. Within the sales process, stage 1 refers to a prospect or client that user 110 has met with for the first time to discuss a potential future sale.

Stage 2 is the marketing submission stage. During this stage, user 110 will begin to compile all the necessary policy information about the new business opportunity. After the user has assembled this information, the information is passed on to the marketing department within the agency or within another entity for carrier submission.

Stage 3 is the delivered proposal stage. Following the submission of the proposal to the marketing staff within an agency, carrier market submission are made, premium quotes are received, and various other tasks occur. Once these processes are complete, the marketing staff will return information to the producer and a proposal is formulated. After formulating a proposal, the producer will present the prospect or existing client with the premium summary.

Stage 4 is the closing stage. This final stage is reached once the existing client or prospect has accepted the proposal. Once an opportunity has reached stage 4, it is no longer tracked within pipeline grid 142.

Stage column 152 in pipeline grid 142 includes an indication of whether the opportunity is within stage 0, 1, 2, or 3. Once an opportunity reaches stage 4, it is no longer displayed in pipeline grid 142, but will reside in one or more reports available from other portions system 100. Agency policy may dictate whether producers within an agency enter stage 0 opportunities into pipeline grid 142, or whether producers wait until the opportunity has reached stage 1, the setting up of an initial appointment, to enter the opportunity into the pipeline grid.

Expiration date column 154 in pipeline grid 142 may indicate an existing policy's expiration date, if the agency of user 110 is the agency of record for the opportunity, or it may indicate the date that user 110 expects to close the new policy. Estimated commission column 156 displays the approximate commission value the agency anticipates producing as a result of a close. Initial appointment column 158, marketing submission column 160, and delivered proposal column 164 each indicate the date on which each of the respective events occurred, which corresponds with entry into stage 1 (initial appointment), stage 2 (marketing submission), and stage 3 (proposal delivery). Carrier submission count column 162 indicates the number of carrier submissions that have been made on the user's behalf by marketing personnel from the user's agency.

Proposal commission column 166 in pipeline grid 142 indicates the agency anticipated commission when the opportunity is closed. In-force commission 168 indicates the annual commission received from the prospect or customer. By definition, the value for in-force commission of a prospect is zero, while existing clients must have an in-force commission value greater than zero.

In one exemplary embodiment, pipeline grid 142 is interactive and can be dynamically edited and customized by user 110. As shown in FIG. 5, selecting a Producer menu 170 will show a list of available producers that user 110 can access to display current opportunities for the selected producer. The number of producers available in producer menu 170 will depend on the access rights given to user 110 by administrator 112. For example, a user 110 may only have access to his or her own pipeline grid 142, or the user may have access to all producers or a portion of producers for which user 110 has supervisory authority within the agency. User 110 will also be able to change the preferred view of pipeline grid 142 by selecting different values in a Group by menu 172, the Use Paging menu 174, and the Page Size menu 176. Group by menu 172 allows user 110 to format pipeline grid 142 to organize and group opportunities for the same account under a common account-level heading, or to remove the common account-level heading. The Use Paging menu 174 and Page Size menu 176 allow the user to determine whether pipeline grid 142 displays paging buttons in a footer. If paging is enabled, the Page Size menu 176 allows the user to display a particular number of opportunities per page.

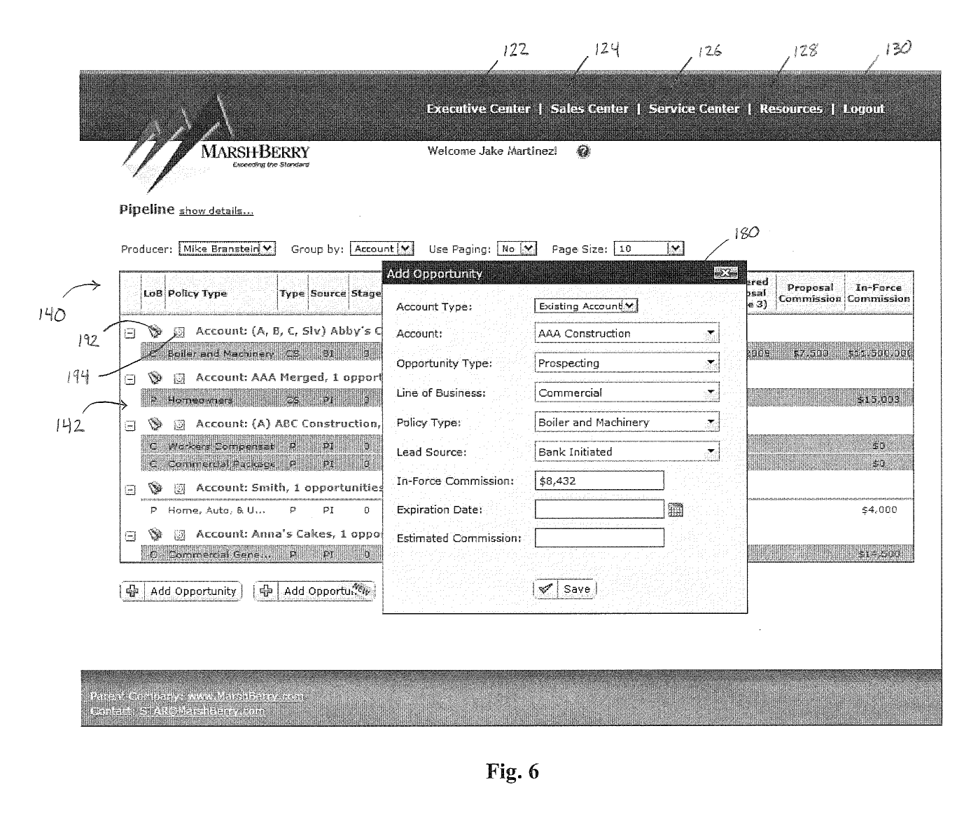

Pipeline page 140 may also include functionality that allows user 110 to add opportunities and to export information. Add Opportunity buttons 178 may allow a user to add a new opportunity to pipeline grid 142. Clicking on one of the Add Opportunity buttons 178 may take user 110 to a separate page within interface 116 where the information regarding the new opportunity can be entered. Alternatively, selecting an Add Opportunity button 178 may call up an Add Opportunity window 180, as shown in FIG. 6, that allows the user to add the desired information without navigating away from the pipeline page 140.

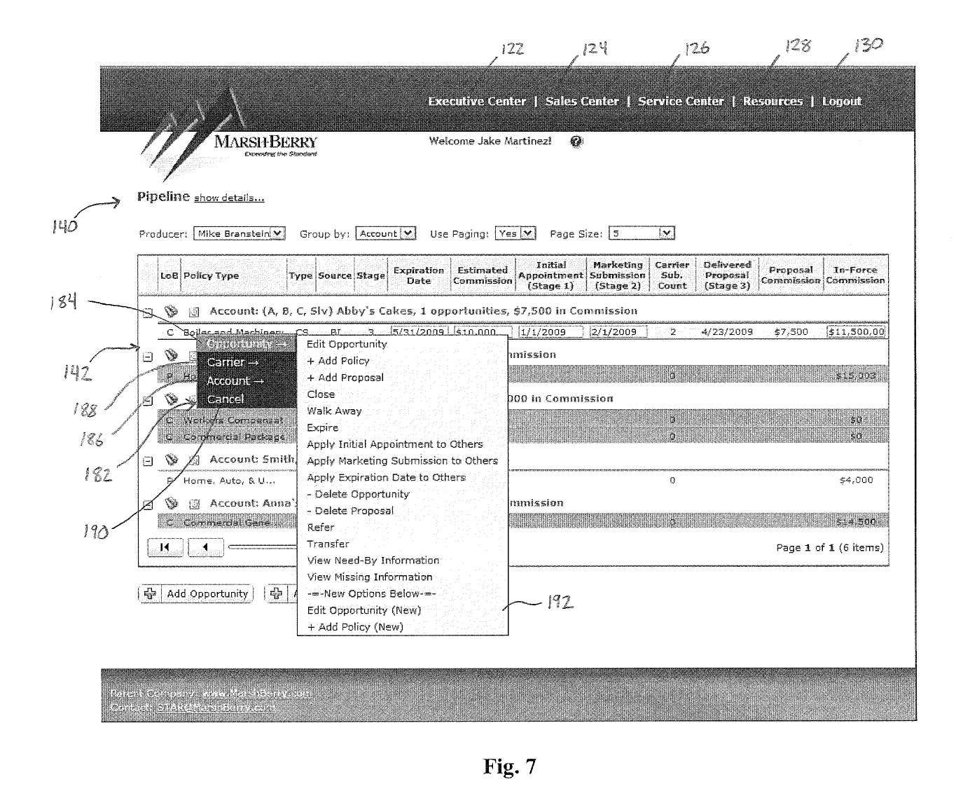

As shown in FIG. 7, pipeline grid 142 may also be edited directly from within pipeline page 140. In one exemplary embodiment, values shown in pipeline grid 142 that relate to stages 1 and 2, including expiration date, estimated commission, initial appointment, marketing submission, and in-force commission can be edited directly by double clicking on an opportunity row within pipeline grid 142, which calls up editable fields for each of the values noted above, as shown in FIG. 7.

To edit stage 3 values for a given opportunity, a user may select the row within pipeline grid 142 where the opportunity is displayed by right clicking, or by other suitable means, which calls up a floating menu 182. Floating menu 182 includes menu options for Opportunity 184, Account 186, Carrier 188 and Cancel 190. Selecting the Opportunity option 184 calls up an Opportunity menu 192, which allows user 110 to edit the opportunity, add or delete a policy or proposal; apply the initial appointment date, marketing submission date, and/or expiration date to other opportunities; refer or transfer the opportunity to another producer; and to view need-by information and missing information. Opportunity menu 192 may also allow user 110 to close the opportunity, walk away from the opportunity, or to indicate that the opportunity has expired.

At any time during the sales process, a producer may choose to walk away from the opportunity. A walk away is when the producer or agency decides that is not in their best interest to continue working with the prospect or existing client to close an opportunity. Walk aways can occur for any number of reasons. For example, a walk away might be appropriate when the producer or agency determines that there is no available market for the opportunity or that the prospect has a history of failing to pay their bills. System 100 allows user 110 to track walk away activity.

An expiration can also occur at any time during the sales process. In contrast to a walk away, an expiration is when a prospect or existing client, rather than the producer, decides to stop pursuing the opportunity. System 100 also allows for the tracking of expiration activity. Designating the opportunity as closed indicates that the prospect or customer has accepted the proposals. Once an opportunity has been closed, it will no longer appear in pipeline grid 142, since the pipeline is used to track opportunities for sales throughout the sales process. In one exemplary embodiment, all of the information regarding the closed opportunities will be available through other portions of user interface 116.

Carrier option 188 in floating menu 182 provides additional functionality for editing the information within pipeline grid 142. Selecting carrier option 188 may call up a carrier menu that will allow user 110 to add or delete a marketing submission or quote and to show interactions between carriers. For example, the carrier menu may provide a convenient way to view a comparison of quotes for premiums that have been received by different insurance carriers.

Account option 186 of floating menu 182 may allow user 110 to access an account menu with functionality for adding a note that is then associated with the selected opportunity. The account menu may also include functionality for viewing notes related to the opportunity and for setting an account type. Pipeline grid 142 may also include a notes icon 192 that provides an alternative method of accessing notes regarding the opportunity. Pipeline grid may also include a reminder icon 194 that will allow user 110 to send a reminder of a date relating to one or more opportunities to an external calendaring program.

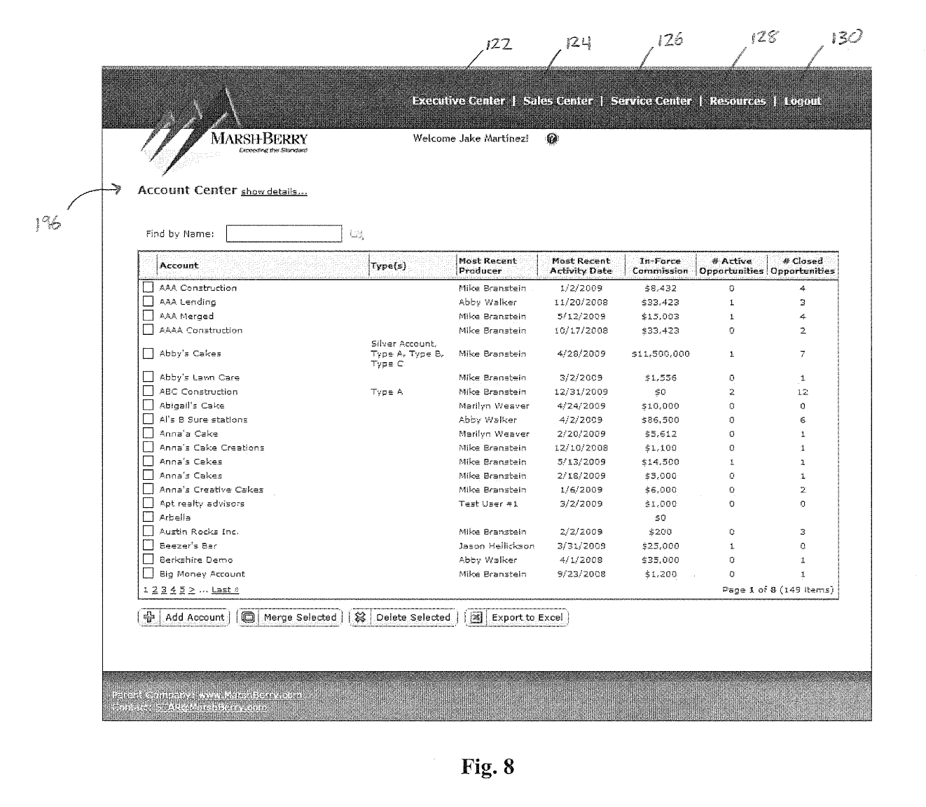

An Account Center page 196, as shown in FIG. 8, is accessed by clicking or otherwise selecting Account Center link 136 from within Sales Center homepage 132 or by selecting the Account Center option from the Sales Center Menu 138. Account Center page 196 provides user 110 with functionality for managing all of the user's accounts. Account Center page 196 may include an account management table 198 that displaying account information for each producer, including account name 200, account type 202, the most recent producer 204 to work on the account, the most recent activity date 206, the in-force commission 208 for each account, the number of active opportunities 210, and the number of closed opportunities 212. Account Center page 196 may also include functionality for adding or deleting an account, merging one or more accounts, and exporting account information into an external spreadsheet application.

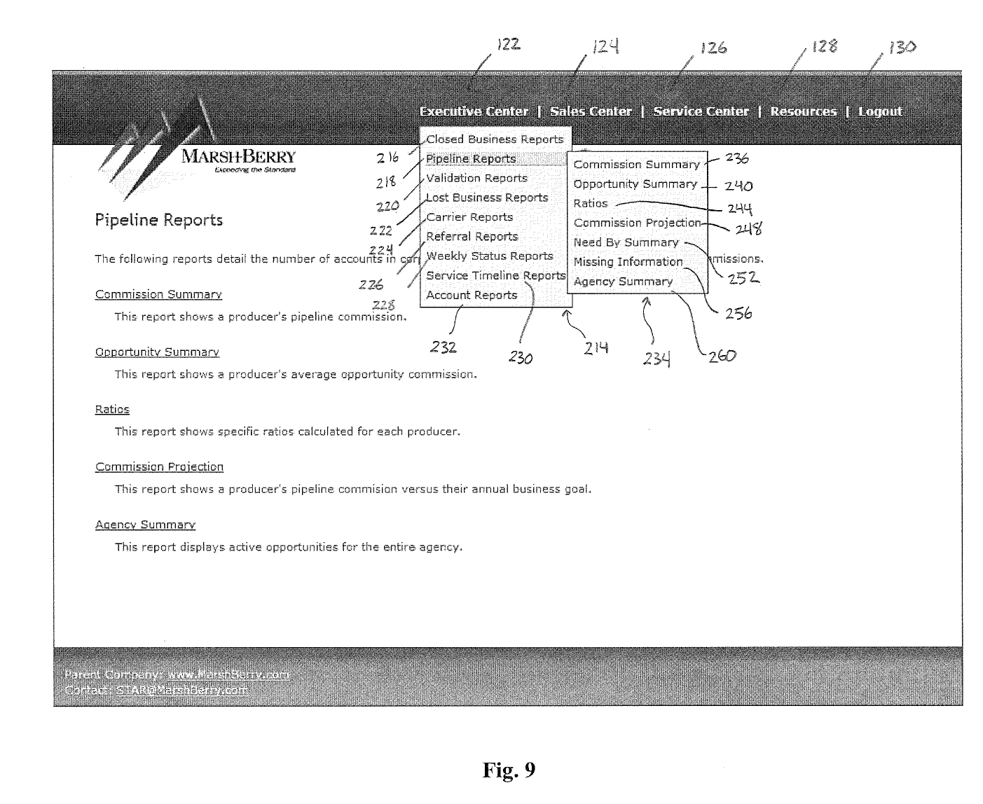

User interface 116 may also include functionality for providing a variety of reports using the data stored within system 100. For example, selecting the Executive Center link 122 may call up an Executive Center menu 214, as shown in FIG. 9. Executive Center menu 214 may include a Closed Business Reports link 216, a Pipeline Reports link 218, a Validation Reports link 220, a Lost Business report link 222, a Carrier Reports link 224, a Referral Reports link 226, a Weekly Status Reports link 228, a Service Timeline Reports link 230, and an Account Reports link 232. In one exemplary embodiment, access to Executive Center menu 214 is limited to executive users 114. In another exemplary embodiment, users 110 may be given limited access to information available through Executive Center menu 214. The functionality of the Executive Center menu 214 provides an agency's management team with essential information for driving organic growth. Reports available through interface 116 may include functionality for filtering, sorting, refreshing, exporting, and otherwise manipulating the data presented so that each executive user 114 can optimize the usefulness of the data presented.

Again referring to FIG. 9, selecting Pipeline Reports link 218 calls up a Pipeline Reports submenu 234, which includes several options for producing pipeline reports. Pipeline reports assist agency personnel in achieving new business goals and in managing and supervising the sales process.

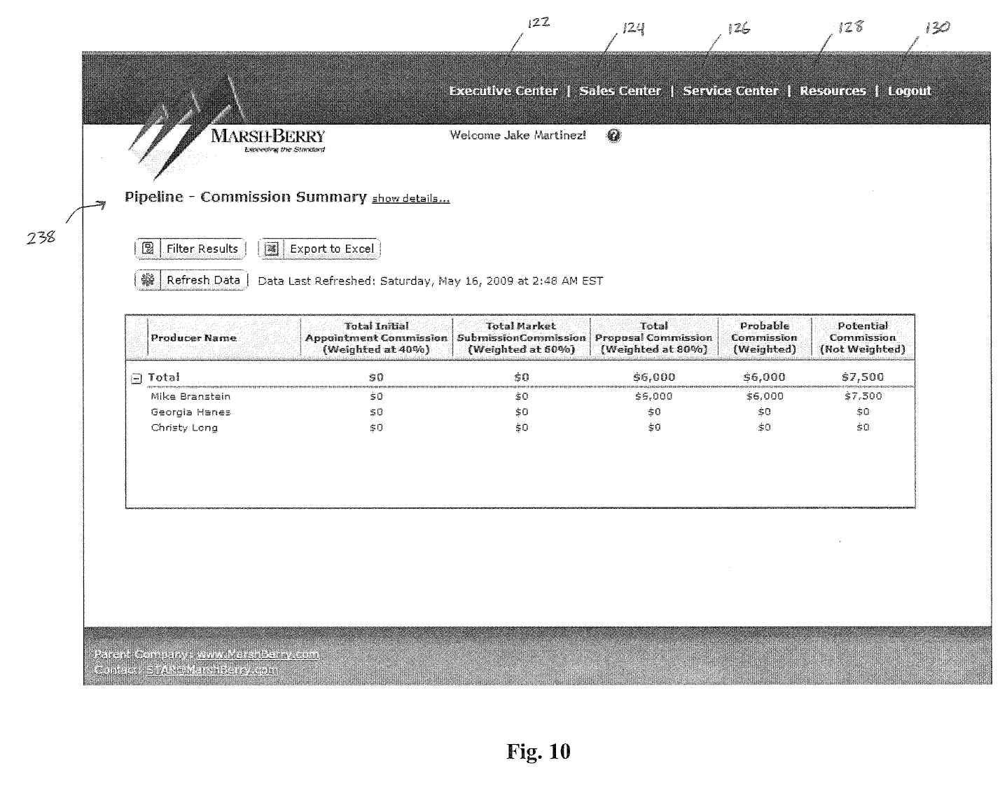

Selecting a Commission Summary link 236 from within Pipeline Reports submenu 234 produces a Pipeline Commission Summary page 238, as shown in FIG. 10. Pipeline Commission Summary page 238 displays a table showing the producer name, as well as the total initial appointment commission, the total market submission commission, the total proposal commission, probable commission, and potential commission for each producer. Pipeline Commission Summary page 238 gives a weighted view of the current state of a potential sale. By using Commission Summary page 238, an executive or other supervisor does not need to inquire how the sales process is going; the executive can simply login to system 100 and view the Commission Summary page 238 to easily observe the sales process from start to finish. This report provides management with greater comprehension of how to work with its producers and make each producer more efficient and productive.

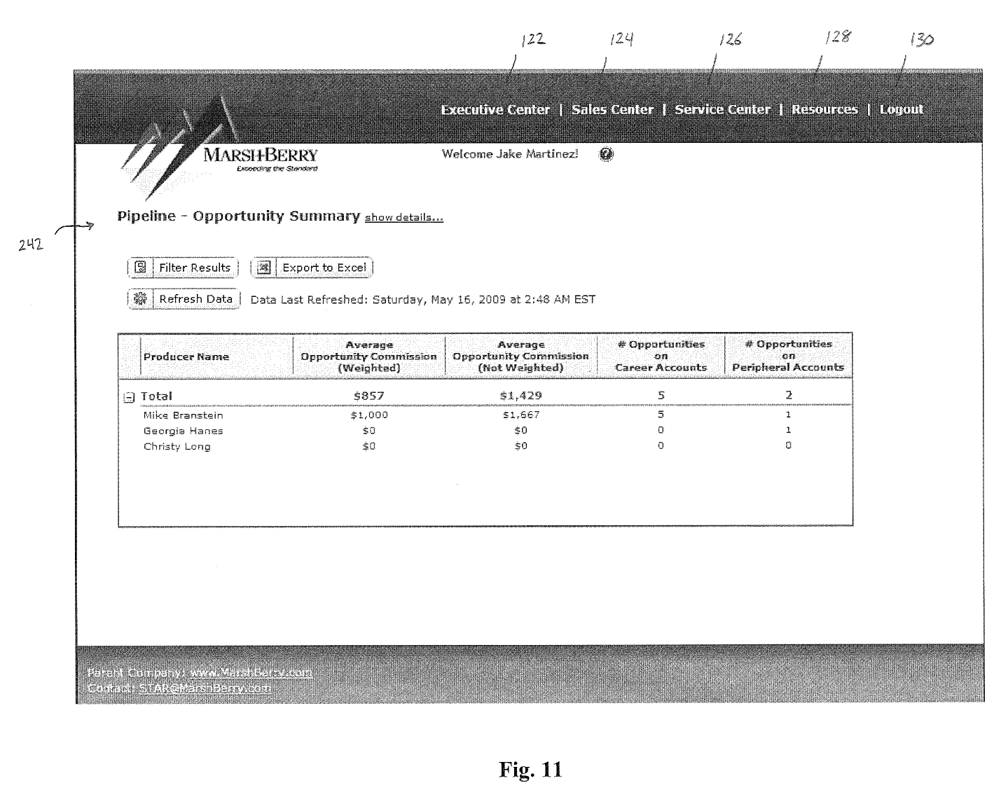

Selecting an Opportunity Summary link 240 from within Pipeline Reports submenu 234 produces Pipeline Opportunity Summary page 242, as shown in FIG. 11. Pipeline Opportunity Summary page 242 displays information including the name of each producer, as well as the average opportunity commission (both weighted and unweighted), number of opportunities on career accounts, and number of opportunities on peripheral accounts for each producer. “Career” and “peripheral” opportunities are decided based upon a calculation performed by system 100. Determination of an opportunity's classification varies by producer, account, and opportunity. The components for classification include a producer's career account threshold, the account's in-force commission, and an opportunity's estimated commission. In one exemplary embodiment, each producer that is tracked within system 100 is assigned a career account threshold by a sales manager. The threshold is commission value that indicates what accounts are considered profitable for a producer to write. To calculate the opportunity classification as career or peripheral, system 100 sums the in-force commission for an account with each opportunity's estimated commission. This value is then compared to a producer's career account threshold. If the value is less than the career account threshold, the opportunity is classified as “peripheral”. Values greater than or equal to the career account threshold are classified as “career”.

Pipeline Opportunity Summary page 242 allows management of an agency to weigh the agency's efforts on both career and peripheral accounts. By tracking individual production efforts as they relate to increasing the size of the accounts that are being targeted, agency management can accurately articulate where and how a new sales focus will impact the agency's bottom line.

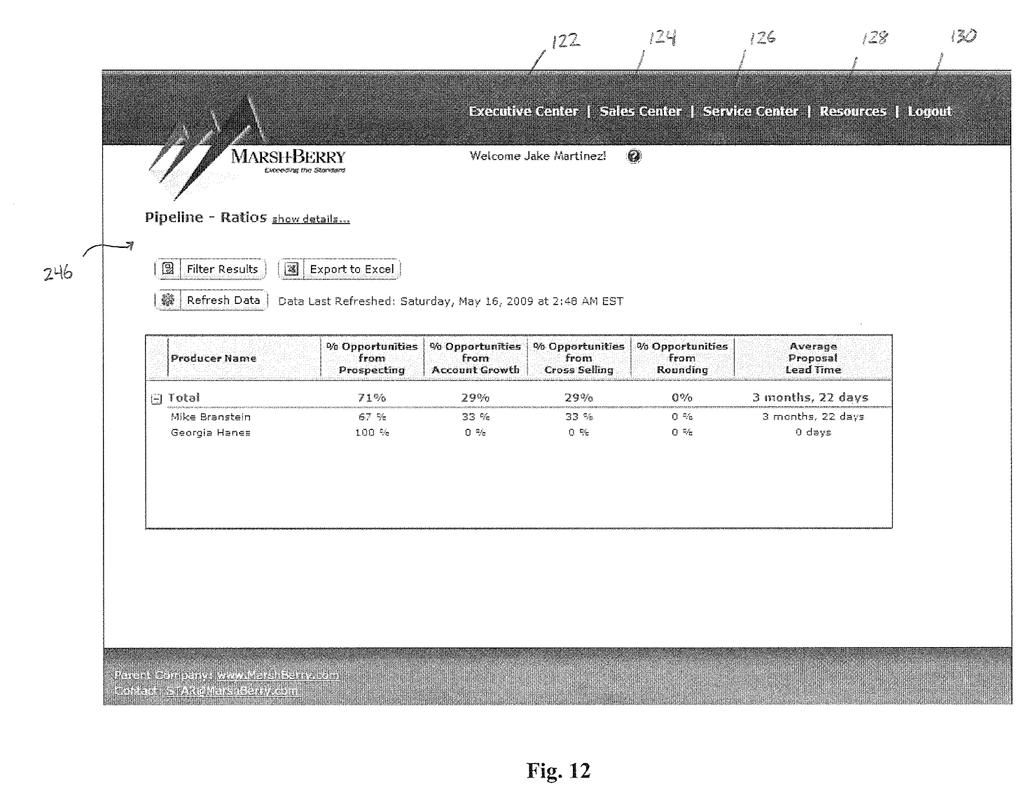

Selecting a Ratios link 244 from within Pipeline Reports submenu 234 s produces Pipeline Ratios page 246, as shown in FIG. 12. Pipeline Ratios page 246 displays a variety of ratios that are calculated for each producer. Pipeline Ratios page 246 may include information such as each producer's name, as well as the percentage of opportunities for each producer that have resulted from prospecting, from account growth, from cross selling, and from rounding, respectively. Pipeline Ratios page 246 may also display the average proposal lead time, measured in months and days, for each producer listed.

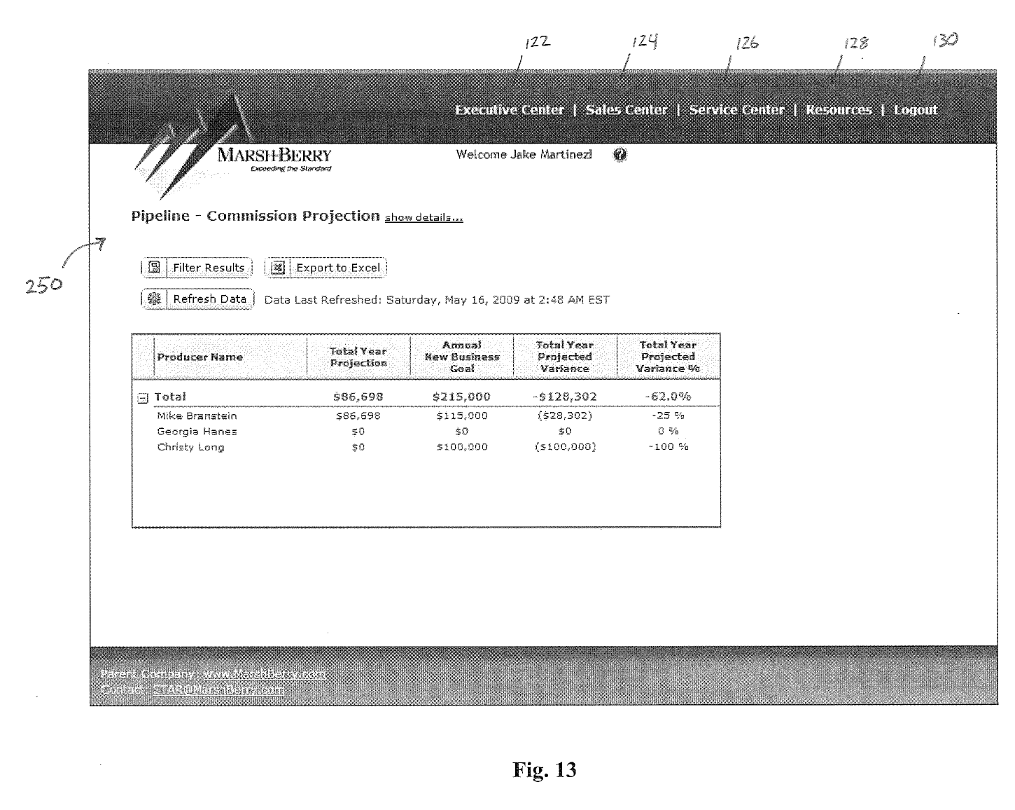

Selecting a Commission Projection link 248 from within Pipeline Reports submenu 234 produces a Pipeline Commission Projection page 250, as shown in FIG. 13, which allows agency management to quickly view a commission versus new business goal snapshot for each producer in the agency. Pipeline Commission Projection page 250 may display the name of each producer, as well as the total year commission projection, annual new business goal, and total year projected variance for each producer in the agency as well as the agency as a whole. Pipeline Commission Projection page 250 allows agency management to capture the performance of an individual producer or location to gain a better understanding of how the producer or location will perform in the future, which allows the agency to implement the corrective measures needed to achieve the agency's business goals.

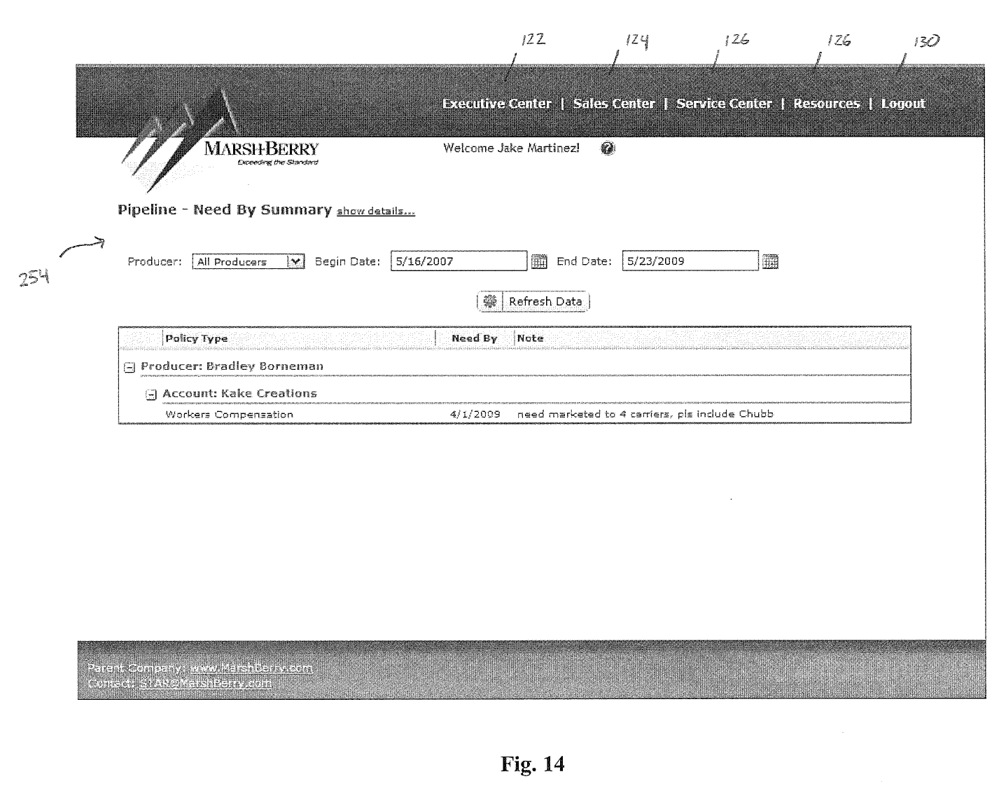

Selecting a Needs By Summary link 252 from Pipeline Reports submenu 234 produces a Pipeline Needs By Summary Page 254, as shown in FIG. 14, that details need-by dates and notes. For example, if a producer has noted within pipeline grid 142 that a certain deliverable is needed by certain date, this data will be visible from the Pipeline Need by Summary Page 254.

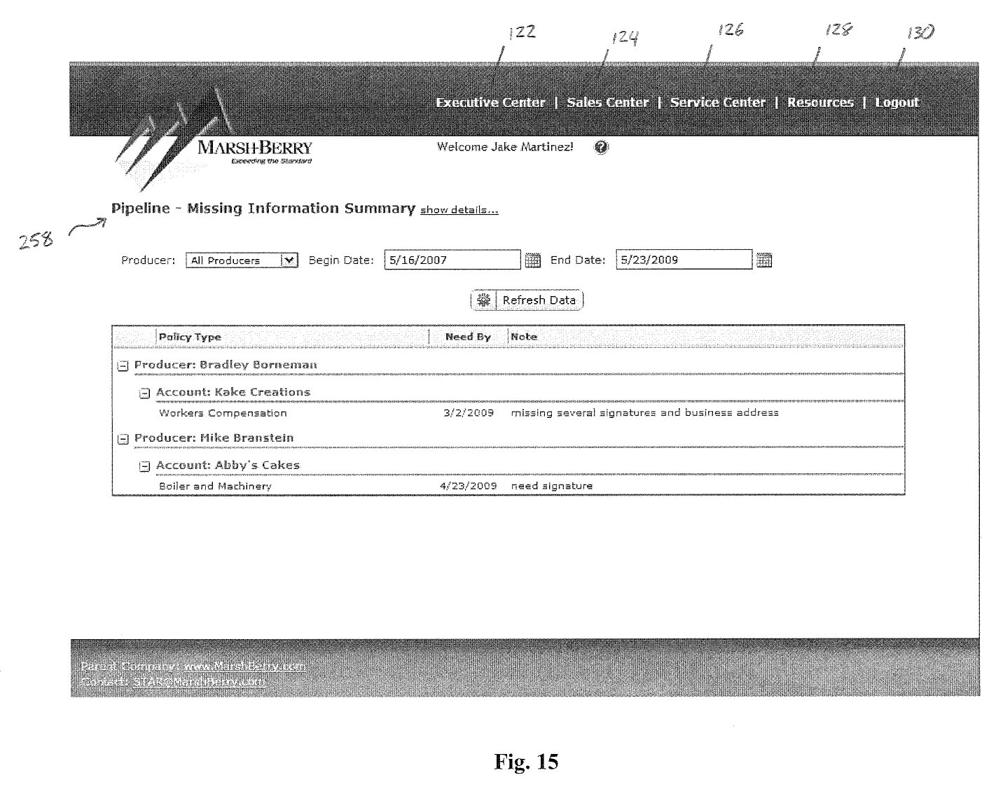

Selecting a Missing Information link 256 from Pipeline Reports submenu 234 produces a Pipeline Needs By Summary Page 258, as shown in FIG. 15, that details information that may be missing from system 100. For example, if a producer has noted within pipeline grid 142 that a certain document delivered from a prospect or customer is missing critical components such as a signature or business address, this data will be visible from the Pipeline Missing Information Summary Page 258.

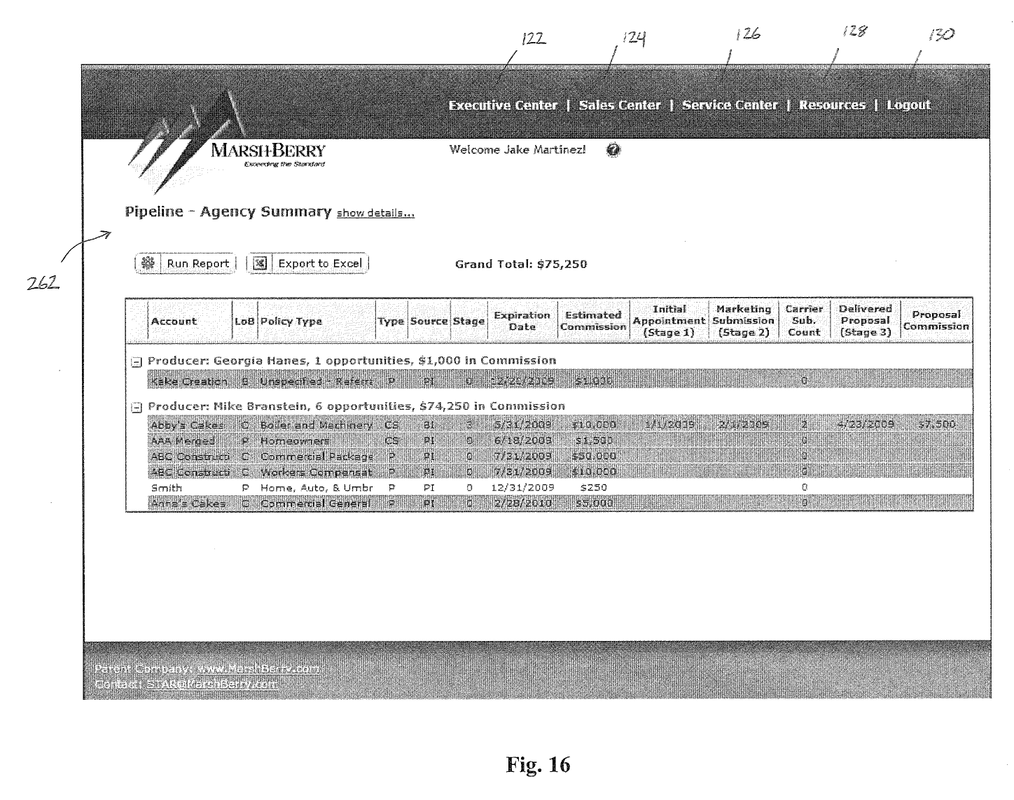

Selecting an Agency Summary link 260 from Pipeline Reports submenu 234 produces an Pipeline Agency Summary page 262, as shown in FIG. 16, which displays all opportunities that are currently within all producer pipelines. Using Pipeline Agency Summary page 262, agency management will be able to quickly get an overview of all activity for all producers in the agency. In one exemplary embodiment, Pipeline Agency Summary page displays data organized under the same or similar headings as those appearing in the individual producer pipeline grids 142, including account, line of business, policy type, type, source, stage, expiration date, estimated commission, initial appointment date, marketing submission date, carrier submission count, proposal delivery date, and proposal commission.

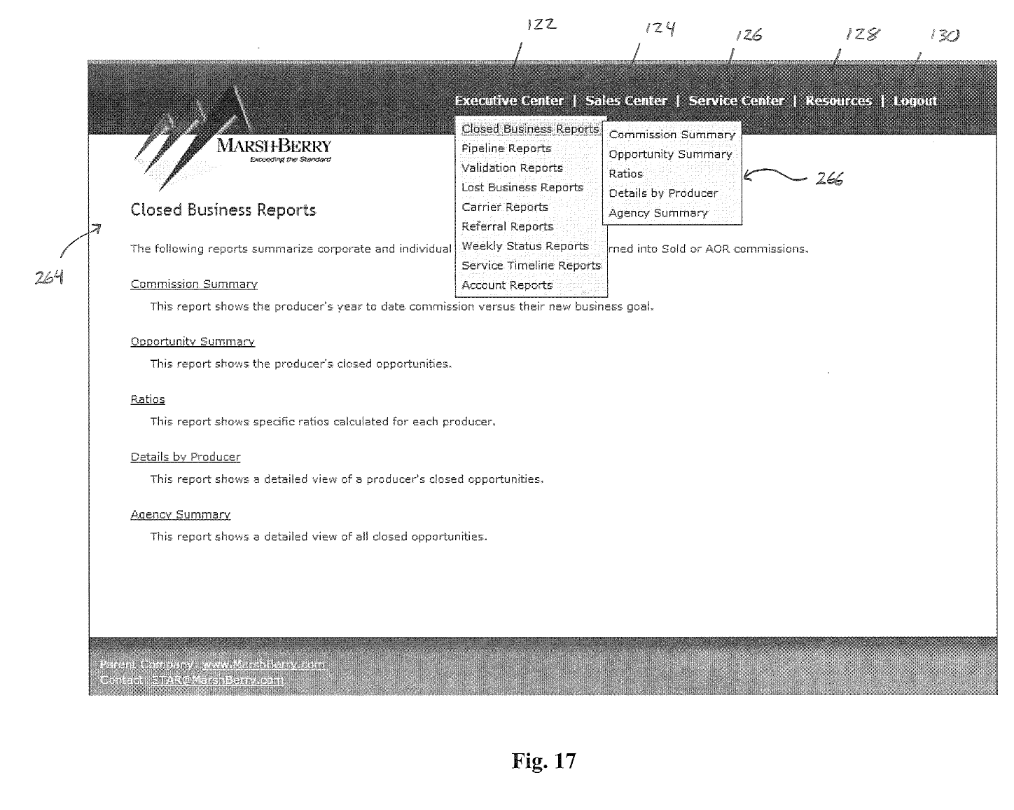

Referring now to FIG. 17, selecting Closed Business Reports link 216 from within Executive Center menu 214 calls up a Closed Business Reports Page 264. Hovering over the Closed Business Reports link 216 may also call up a Closed Business Reports submenu 266. A variety of closed business reports are accessible from either Closed Business Reports page 264 or Closed Business Reports submenu 266. As shown in FIG. 17, the available closed business reports include a commission summary, an opportunity summary, a report detailing ratios, a report showing details by producer, and an agency summary.

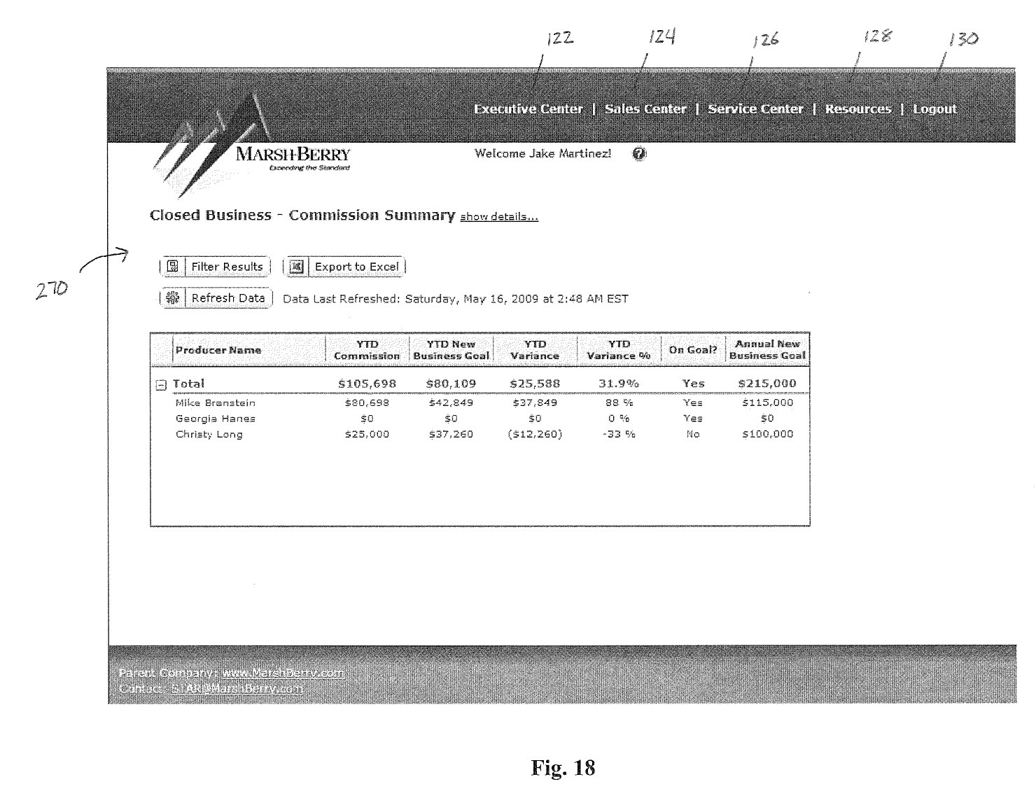

FIG. 18 illustrates a Closed Business Commission Summary page 270 accessed from Closed Business Reports Page 264. This page allows agency management to view at a glance those producers who are leading new business efforts within the organization, and whether the agency is on track to reach a predetermined annual new business goal. Closed Business Commission Summary page 270 may display information including the name of each producer, as well as the year-to-date commission, the year-to-date new business goal, the year-to-date variance, the annual new business goal for each producer listed, and for the entire agency or organization. Commission Summary page 270 may also provide an indication of whether each producer and the agency as a whole is on target to reach a predetermined goal.

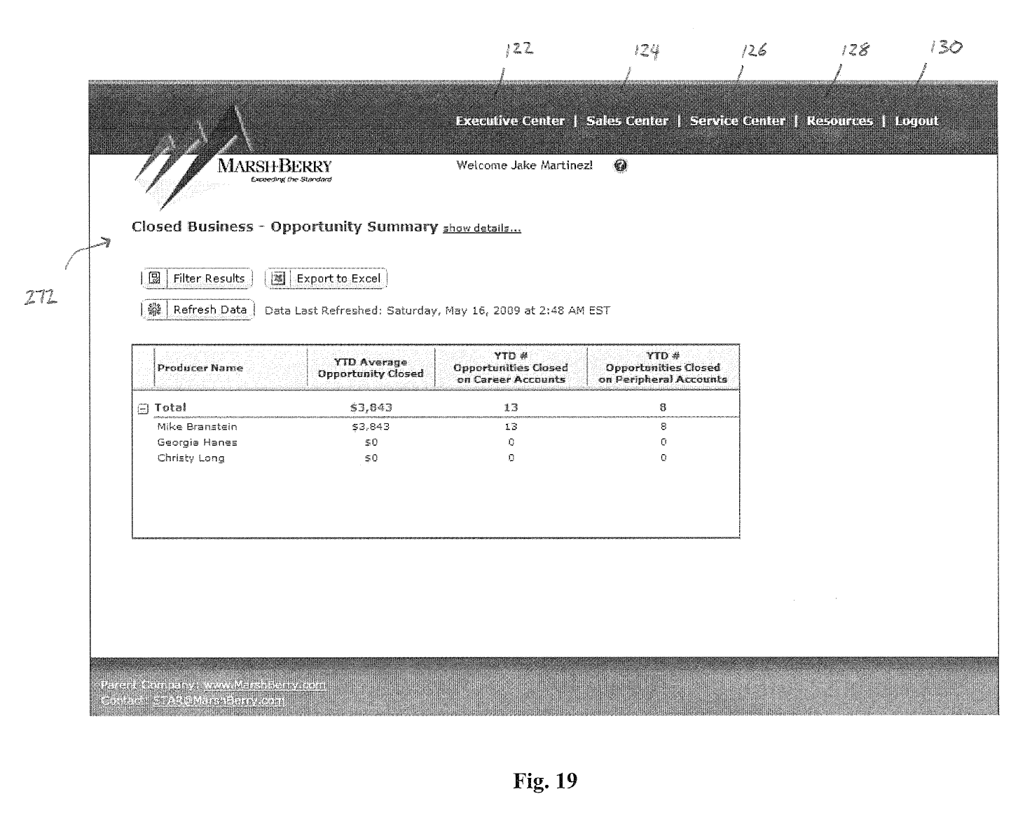

FIG. 19 illustrates a Closed Business Opportunity Summary page 272 accessed from Closed Business Reports Page 264. This page allows agency management to gain a clear understanding of what the closing rates are for the agency during any given time period and to focus on increasing the closing rates before the close of the business year. Closed Business Opportunity Summary page 272 may display information including the name of each producer, as well as the year-to-date dollar amount for the average opportunity closed, the year-to-date number of opportunities closed on career accounts and the year to date number of opportunities closed on peripheral accounts, for each producer and for the entire agency.

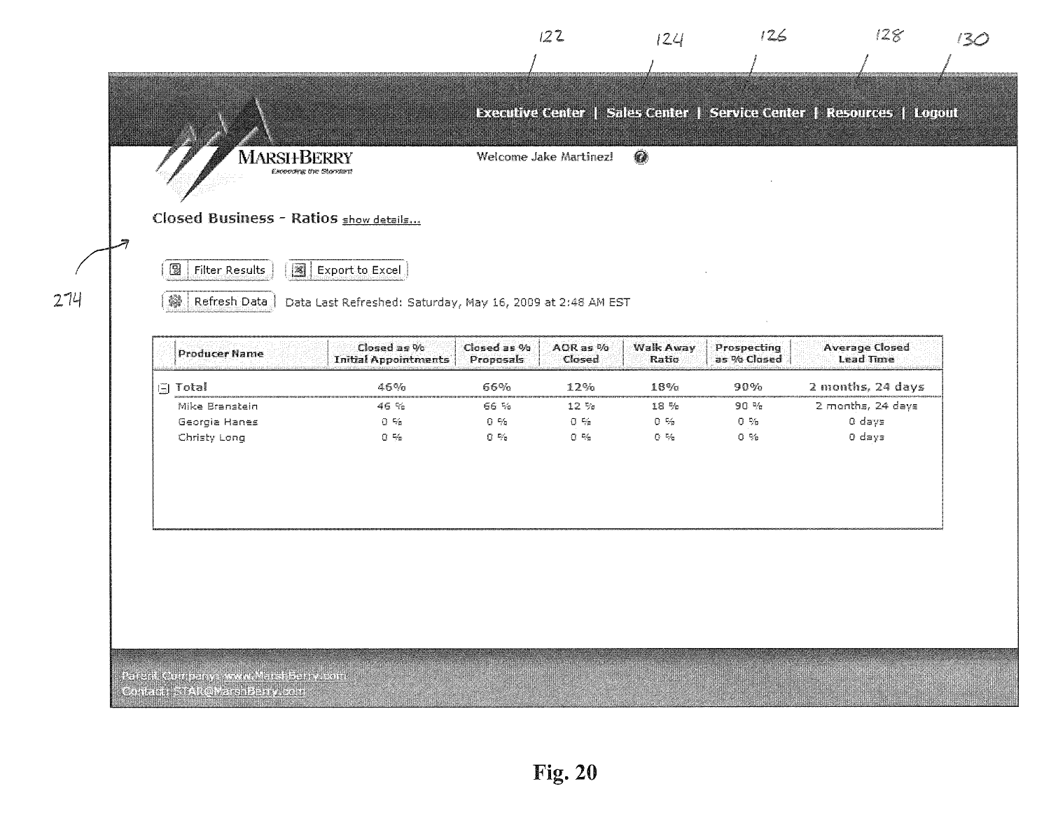

FIG. 20 illustrates a Closed Business Ratios page 274 accessed from Closed Business Reports Page 264. This page allows agency management to pinpoint those area that will best assist producers in maximizing their performance. Closed Business Ratio page 274 may display information including the name of each producer, as well information for each s producer and for the entire agency that includes the number of opportunities closed as a percentage of initial appointments, the number of closed opportunities as a percentage of total proposals made, the percentage of opportunities closed for which the organization is the agency of record, the walk away ratio (percentage of total opportunities that producer decides to walk away from), the percent of closed opportunities that were the result of prospecting, and the average lead time to close for each closed opportunity.

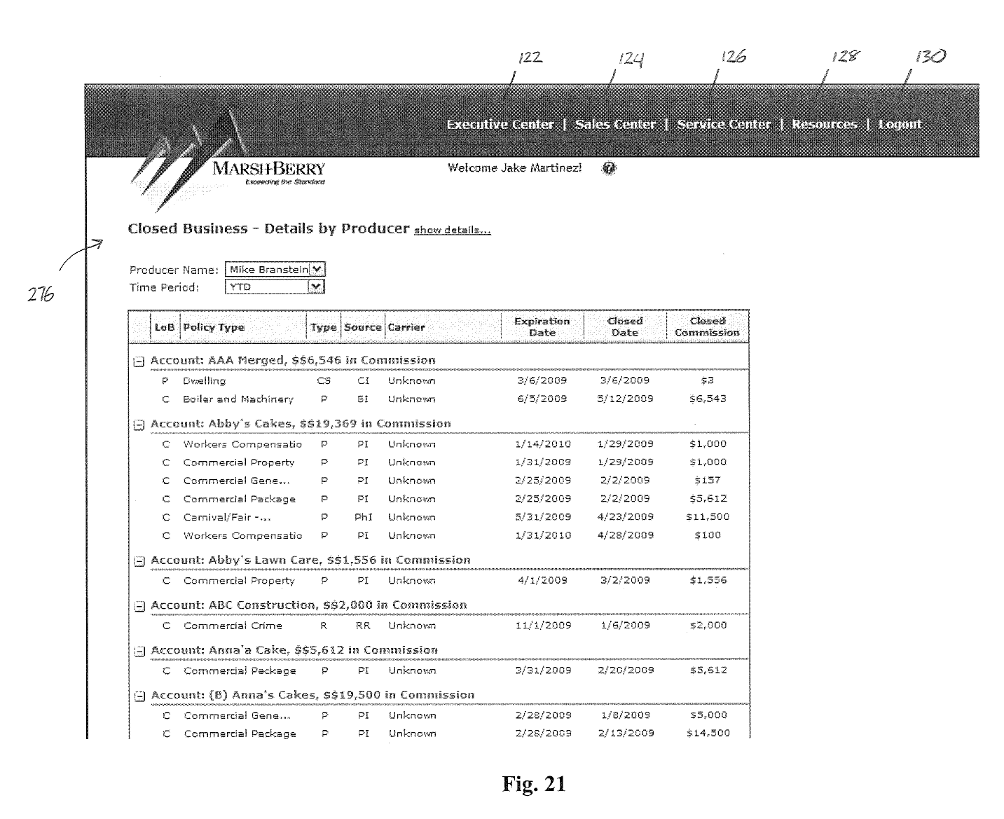

FIG. 21 illustrates a Closed Business Details by Producer page 276, accessed from Closed Business Reports Page 264. The Business Details by Producer page 276 allows agency management to monitor each producer's progress for a specific time period or for the producer's entire career. This page allows agency management to identify the types of business, policy types, carriers that producer typically works with to determine whether the producer is growing his or her book of business in a consistent manner.

Details by Producer page 276 may include specific information regarding each of the opportunities closed by a selected producer, which allows an executive user to drill down into the details of the closed opportunities. Information that may be displayed on the Details by Producer page includes a grouping of the selected producer's closed opportunities by account, including a listing of the closed opportunity's line of business, policy type, type, source, carrier, expiration date, date the opportunity was closed, and amount of the commission earned by the producer for the closed opportunity. Details by Producer page 276 may also include functionality for selecting any producer in the agency that is entered into system 100, as well as a range of dates for which information will be displayed.

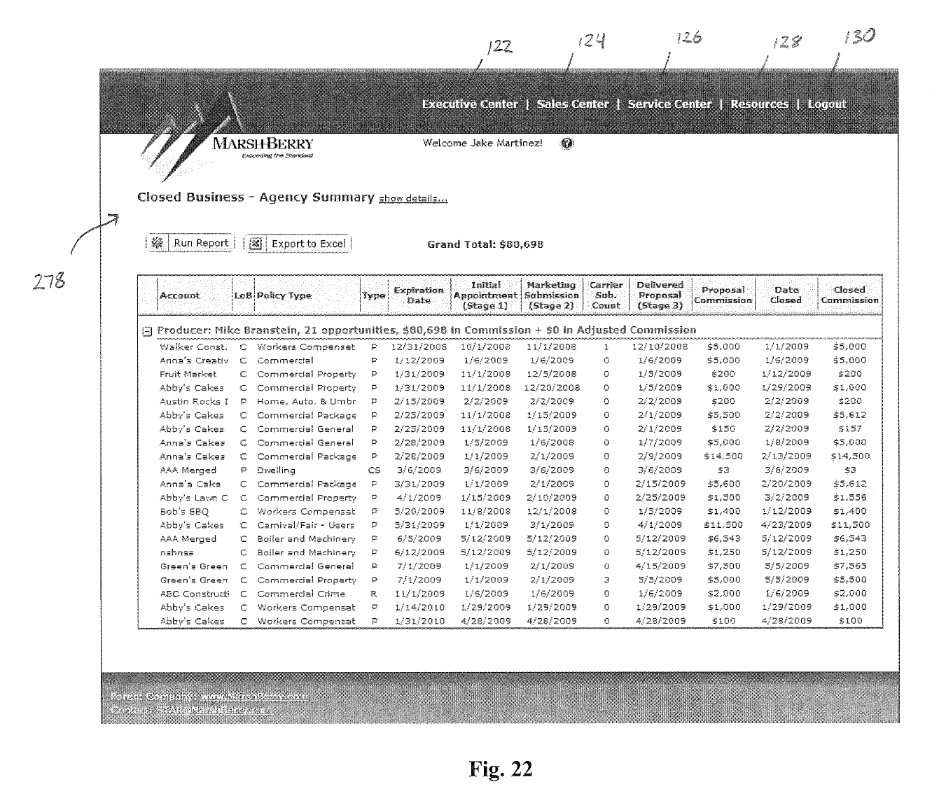

FIG. 22 illustrates a Closed Business Agency Summary page 278, accessed from Closed Business Reports Page 264. Agency Summary page 278 provides an overview the data relating to all closed opportunities within an agency. The data may be broken down by producer and may include the account name, line of business, policy type, type, expiration date, initial appointment date, marketing submission date, carrier submission count, proposal delivery date, proposal commission amount, the date closed, and the amount of commission earned on the closed opportunity. Agency Summary page may also include a grand total showing the total commission earned by the agency for all closed opportunities.

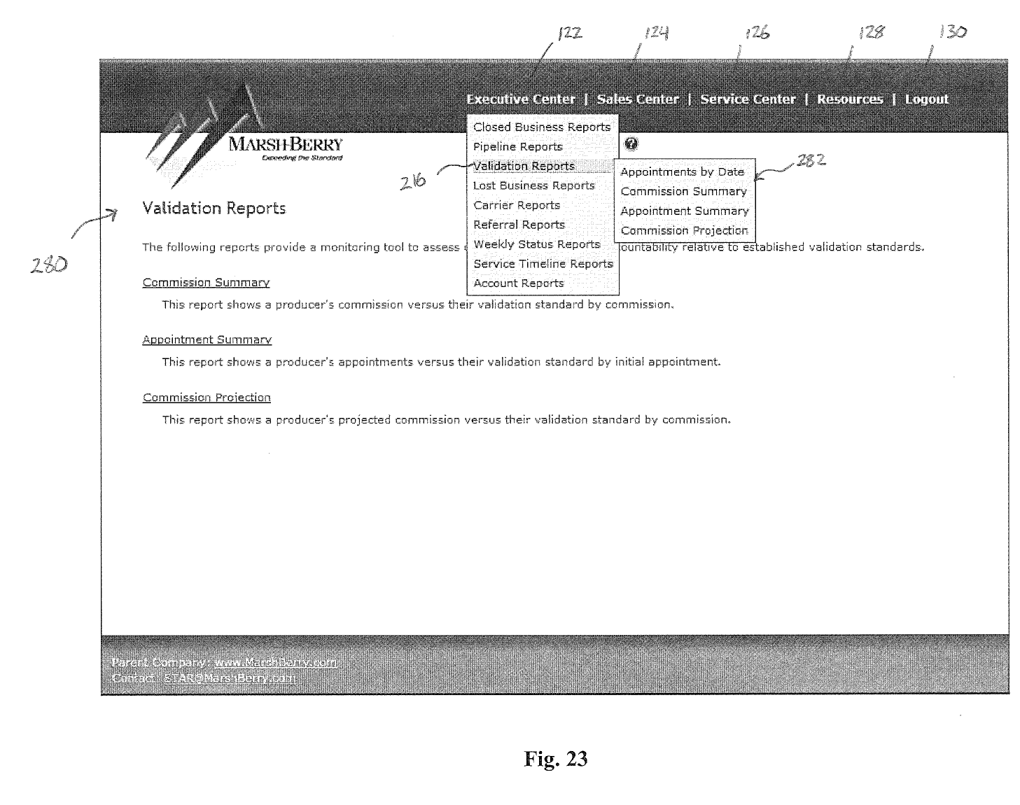

Referring now to FIG. 23, selecting Validation Reports link 220 from within Executive Center menu 214 calls up a Validation Reports Page 280. Hovering over the Validation Reports link 216 may also call up a Validation Reports submenu 282. Validation reports allow an agency's management team to track the progress of the agency's producers against predetermined validation standards. A variety of validation reports are accessible from either Validation Reports page 280 or Validation Reports submenu 282. As shown in FIG. 23, the available validation reports include an appointments by date report, a commission summary report, an appointment summary report, and a commission projection report.

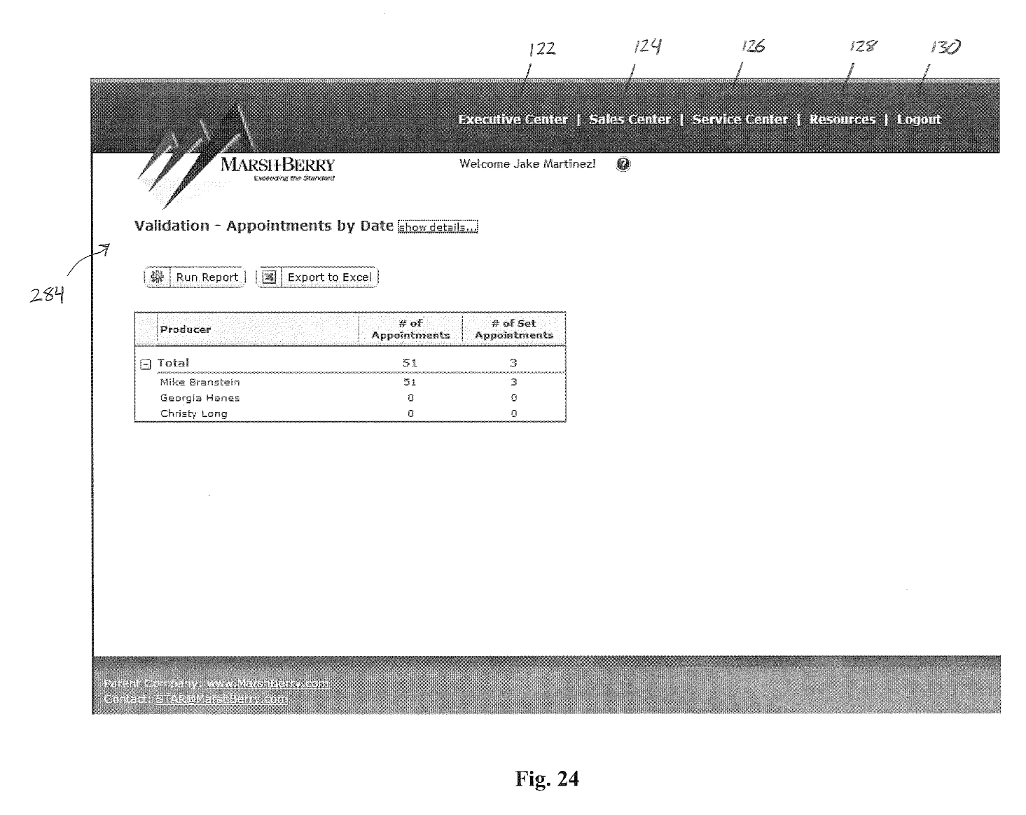

FIG. 24 illustrates an Appointments by Date page 284 accessed from Validation Reports page 280. Appointment by Date page 284 includes a listing of one or more agency producers as well as the number of appointments and number of set appointments for each producer during a set time period.

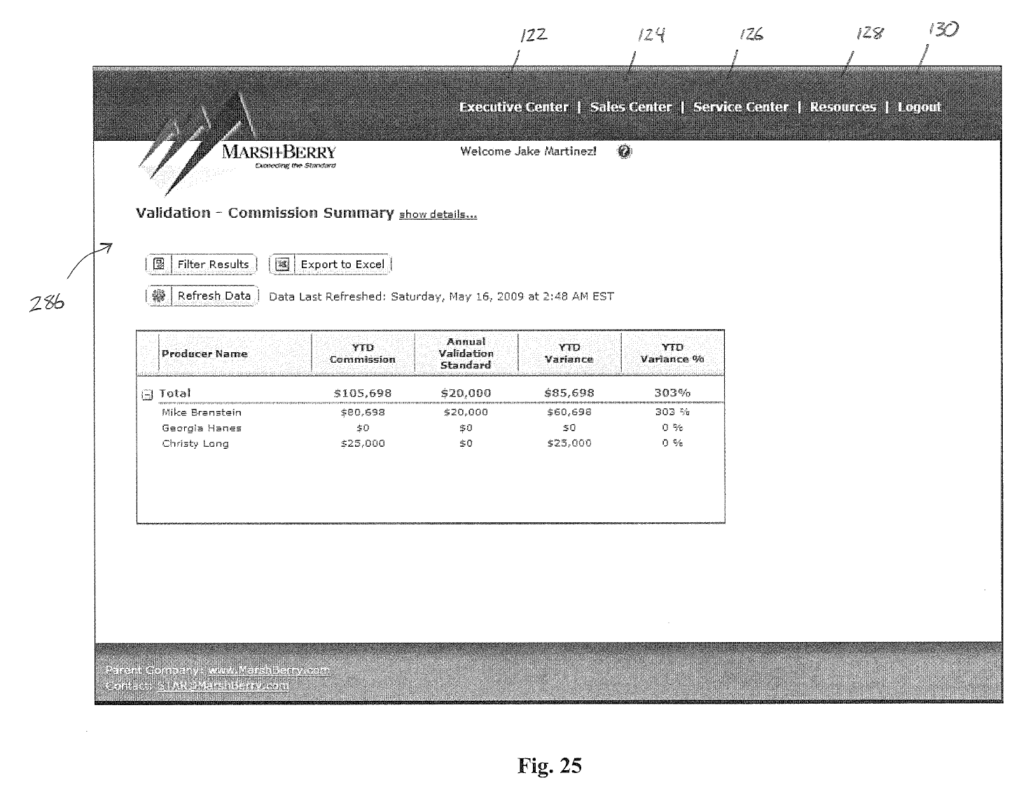

FIG. 25 illustrates a Commission Summary page 286 accessed from Validation Reports page 280. Validation Commission Summary page 286 includes a listing of one or more agency producers as well information regarding year-to-date commission, annual validation standard, and year-to-date variance between the commission and the validation standard. In this case, the validation standard is a value representing an expected minimum threshold commission. This information may be provided for each producer as well as for the entire agency or organization.

In one exemplary embodiment, an executive user 114, such as an agency manager, is able to set a validation standard for each producer. In another exemplary embodiment, the validation standard is taken from comparative industry data. Validation Commission Summary page 286 gives an agency's management a quick and easy view of where new producers are in relation to the new producer's validation schedule. The sooner a determination regarding the viability of a new producer can be made, the sooner management can evaluate and project new business income and decrease the bottom line impact of a salaried producer.

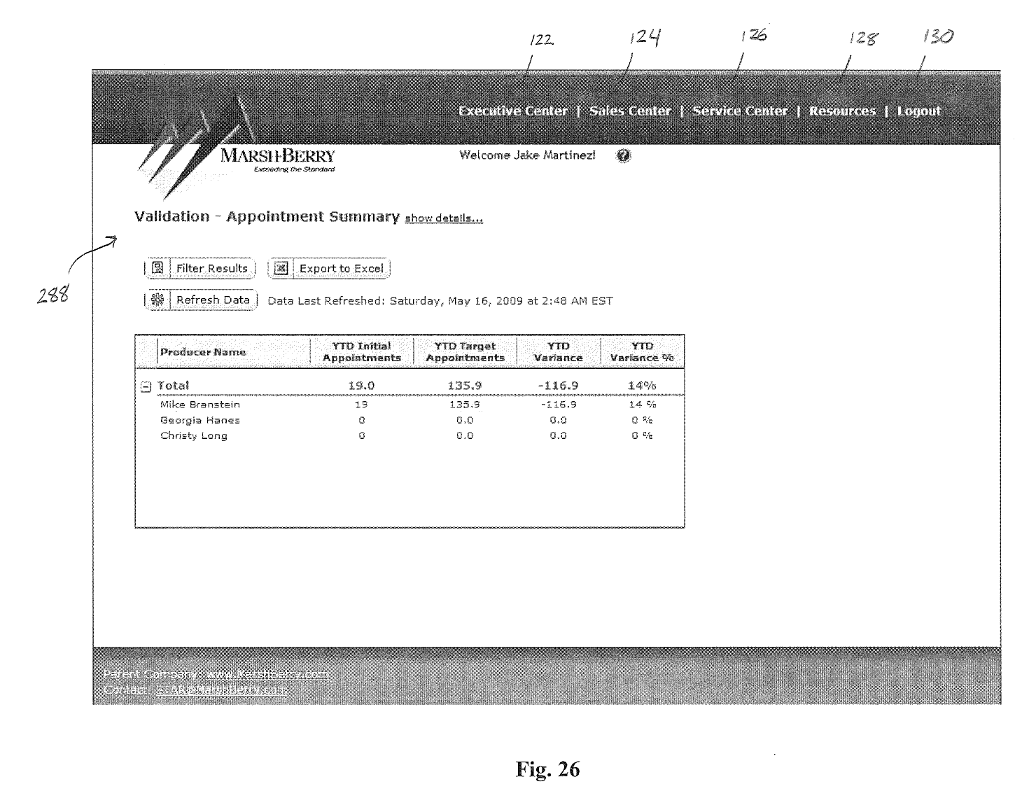

FIG. 26 illustrates an Appointment Summary page 288 accessed from Validation Reports page 280. Validation Appointment Summary page 288 displays the name of one or more producers as well as information for each individual producer regarding year-to-date initial appointments, year-to-date target appointments, and year-to-date variance between the two. The variance may be expressed as a raw number and/or as a percentage. The quickest way for a producer within an agency to validate, that is, to demonstrate a level of competency by earning a threshold commission amount, is to be on as many appointments as possible. Validation Appointment Summary page 288 allows an agency manager to efficiently supervise the appointment process.

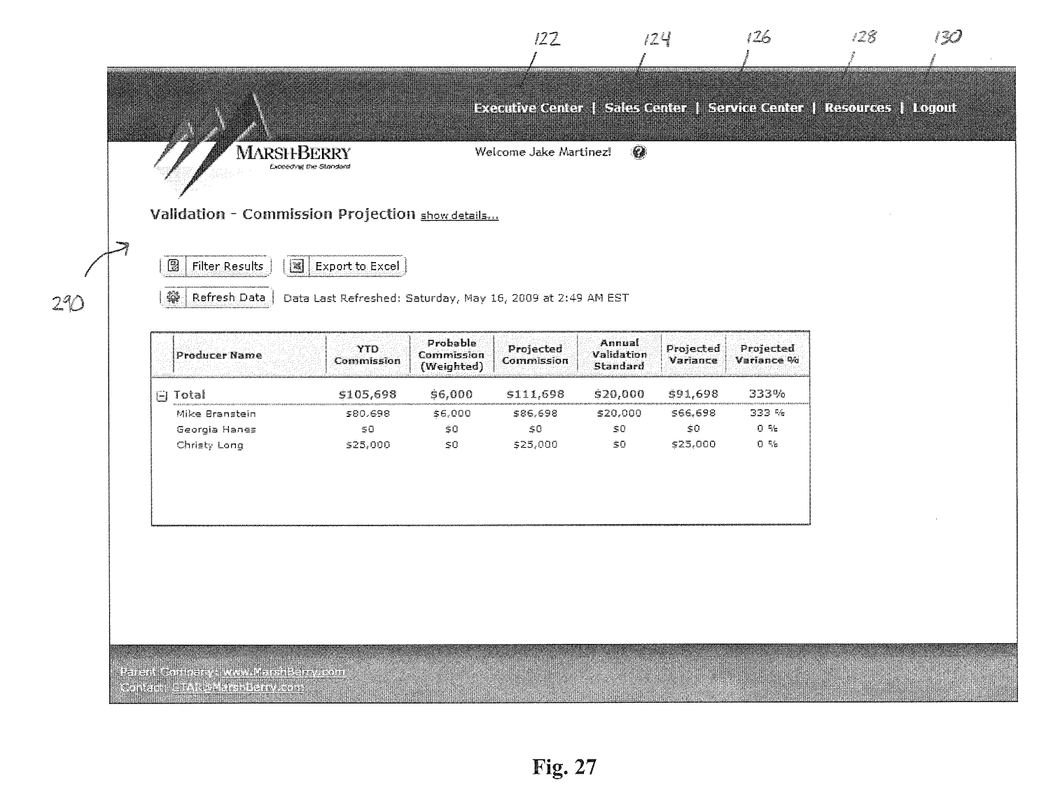

FIG. 27 illustrates a Commission Projection page 290 accessed from Validation Reports page 280. Validation Commission Projection page 290 displays information regarding the commission for each producer projected over an entire year. Validation Commission Projection page 290 may include the names of the individual producers as well as the year-to-date commission, probable commission, projected commission, annual validation standard, and projected variance for each producer. The probable commission may be weighted. Commission Projection page 290 allows agency management to keep new producer costs to a minimum and to add new producers quickly and effectively if needed.

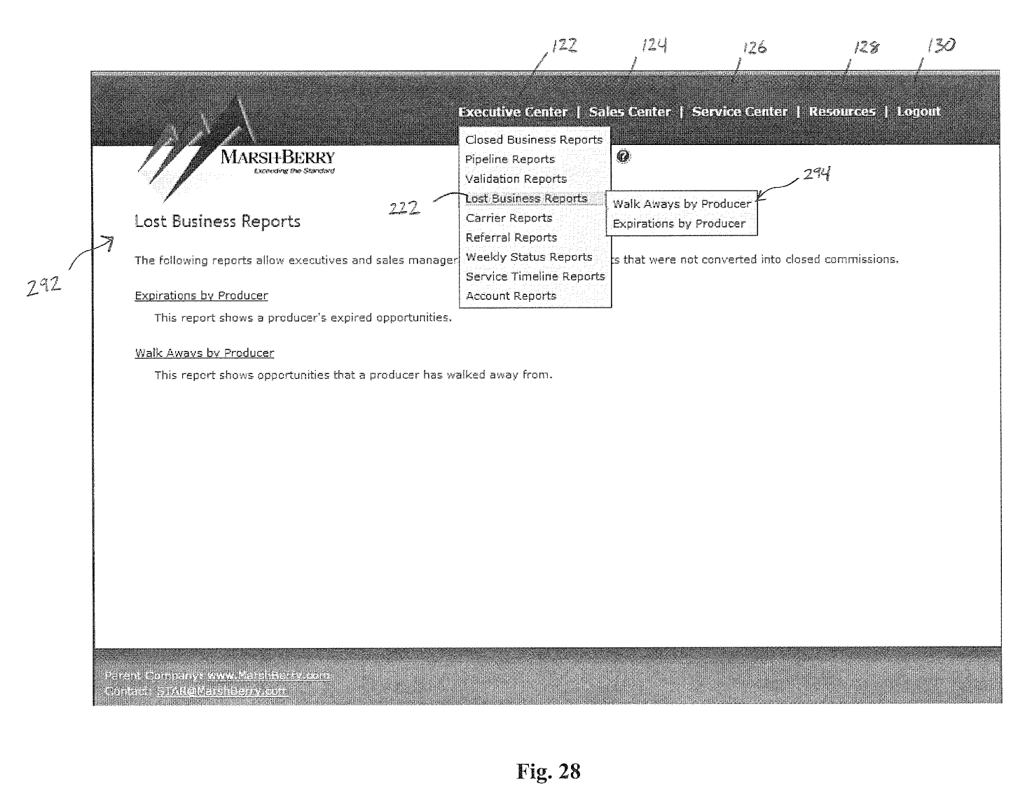

Referring now to FIG. 28, selecting Lost Business Reports link 222 from within Executive Center menu 214 calls up a Lost Business Reports Page 292. Hovering over Lost Business Reports link 222 may also call up a Lost Business Reports submenu 294. Lost Business Reports page 292 provides a way for agency management to get a handle on opportunity accounts that have been worked on in the past but did not close for one reason or another. Lost Business Reports submenu 294 as well as Lost Business Reports page 292 include links to a pages that display the opportunities that the producer decided to stop pursuing (walk aways) and opportunities that the client or prospective client decided to stop pursuing (expirations).

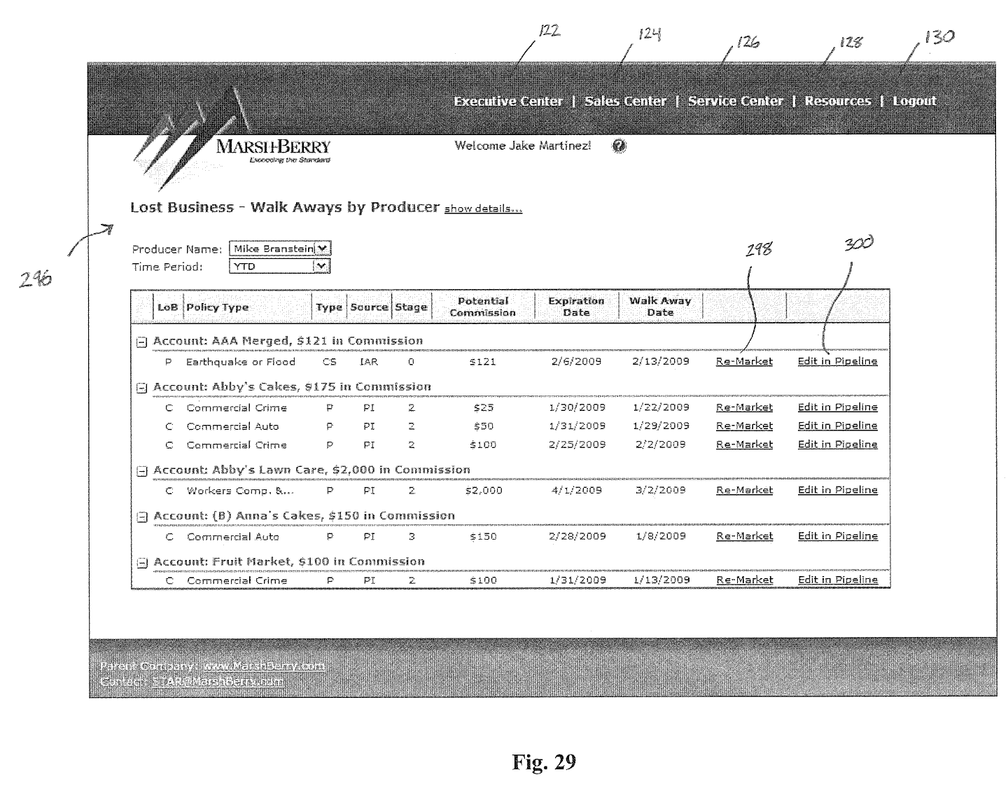

FIG. 29 illustrates a Walk Aways by Producer page 296 accessed from Lost Business Reports page 292. Walk Aways by Producer page 296 displays the opportunities for a selected producer grouped by account. Other information that may be displayed on the page include the line of business of the opportunity, the policy type, source, stage, potential commission, expiration date, and walk away date. Walk Aways by Producer page 296 may also include a Re-Market link 298 and a Edit in Pipeline link 300. Clicking or otherwise selecting Re-Market link 298 will automatically re-market the selected opportunity by adding the opportunity back into the selected producer's pipeline grid 142. Edit in Pipeline link 300 will allow a user to edit the selected lost business opportunity from within pipeline grid 142. Walk Aways by Producer page 296 allows a user to track which opportunities have been left behind and why, to ensure that an agency's individual producers are pursuing opportunities that conform to the agency's goals and sales culture.

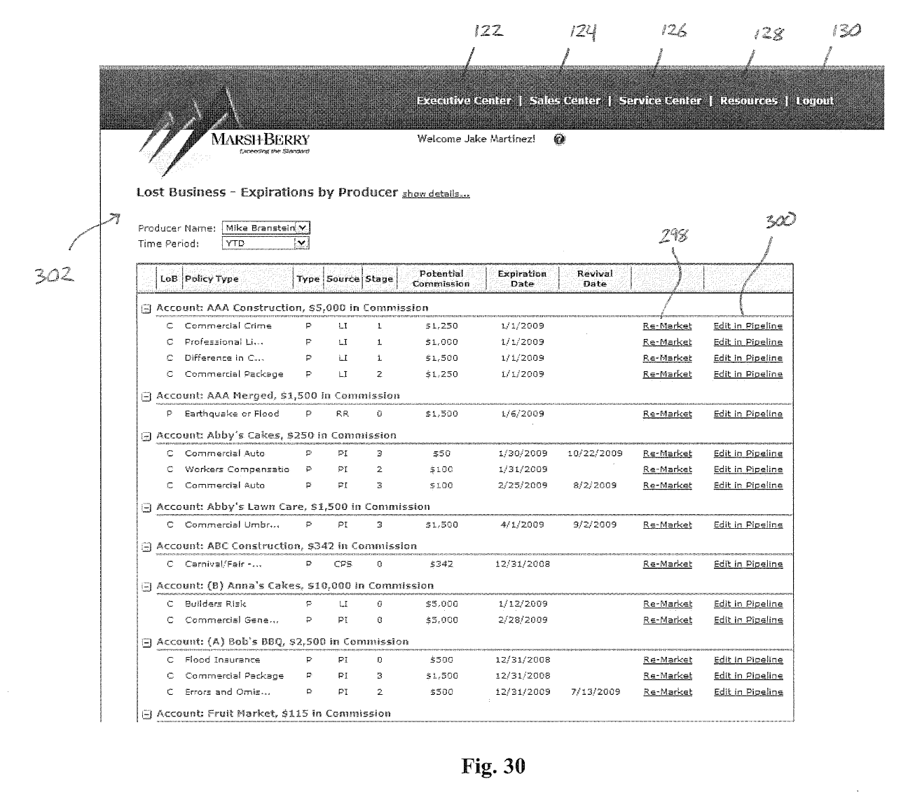

FIG. 30 illustrates an Expirations by Producer page 302 accessed through Lost Business Reports page 292. Expirations by Producer page 302 is similar to Walk Aways by Producer page 296, and includes Re-Market links 298 and Edit in Pipeline links 300. Expirations by Producer page 302 provides a snapshot of opportunities that were lost at the initiative of the client or prospective client, and allows agency management to reassign a lost opportunity to a different producer within the agency who may have greater success with the opportunity. Expirations by Producer page 302 may also include functionality for sending a prospect to an external calendaring program for follow-up.

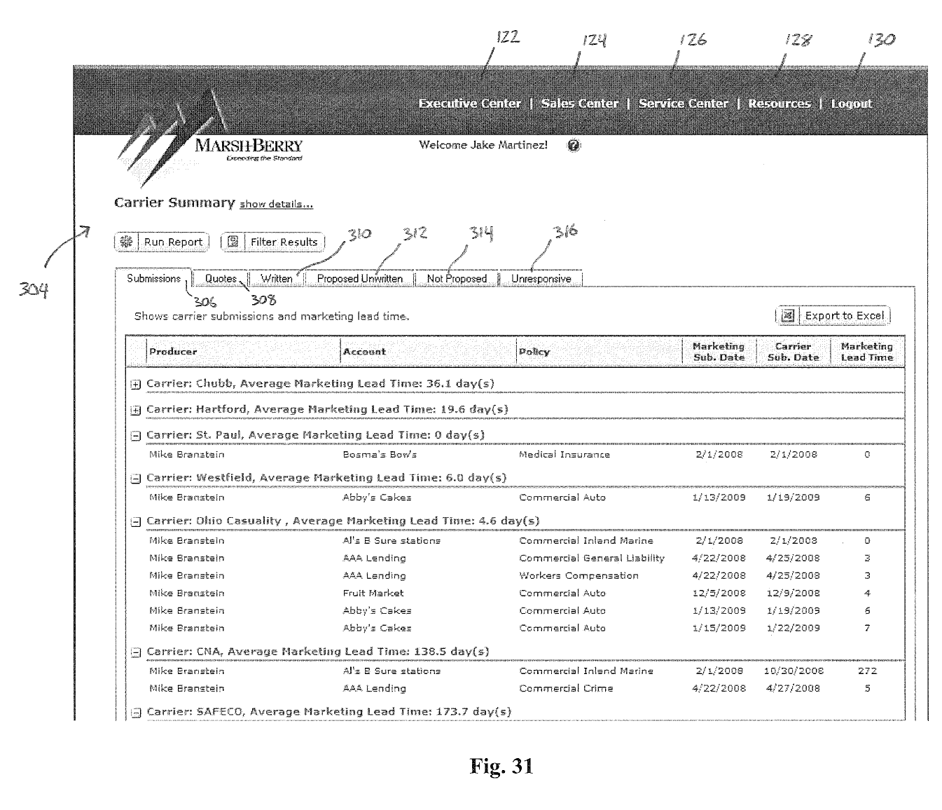

FIG. 31 illustrates a Carrier Summary page 304 that can be accessed by selecting the Carrier Reports link 224 on the Executive Center menu 214. Typically, insurance agencies deal with a wide variety of insurance carrier partners. Carrier partners can bring new business development to a standstill if the partners are not properly managed. Carrier Summary page 304 allows agency management to track all of the agency's producer submissions to carrier partners clearly and concisely. Reporting functionality within user interface 116 provides a streamlined procedure for reporting the status of carrier submissions. Carrier Summary page 304 includes a plurality of tabs including a Submissions tab 306, a quotes tab 308, a Written tab 310, a Proposed Unwritten tab 312, a Not Proposed tab 314, and an Unresponsive tab 316.

Submissions tab 306 provides access to information regarding the opportunities that have been submitted to each carrier partner. The information may include the producer who submitted the opportunity, the account, the policy, the marketing submission date, the carrier submission date, and the marketing lead time.

Quotes tab 308 provides access to information regarding quotes that have been submitted by the carriers, including the amount of the quote, and the lead time in receiving the quote, that is the difference between the carrier submission date and the date the quote was received from the carrier.

Written tab 310 shows proposed carrier quotes resulting in closed opportunities. Proposed Unwritten tab 312 shows proposed carrier quotes that have not been written. Not Proposed tab 314 displays information regarding quotes that were received but never proposed to the prospective client. Finally, Unresponsive tab 316 shows carrier interactions for which a quote has not yet been received.

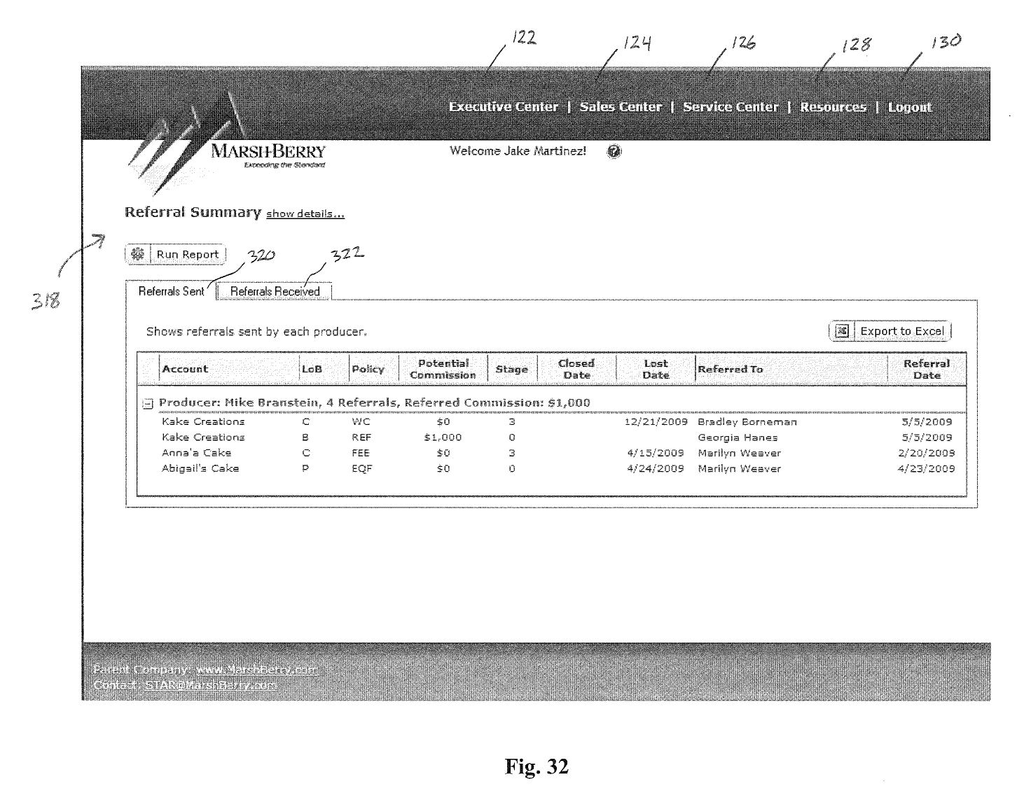

FIG. 32 illustrates a Referral Summary page 318 accessed by selecting Referral Reports link 226 from within Executive Center menu 214. Referral Summary page 318 includes two tabs, Referrals Sent tab 320 and Referrals Received tab 322. Referral Summary page 318 allows agency management to track referrals between producers within the agency to determine whether the referrals are acted upon in a timely manner and whether the referrals have been effective.

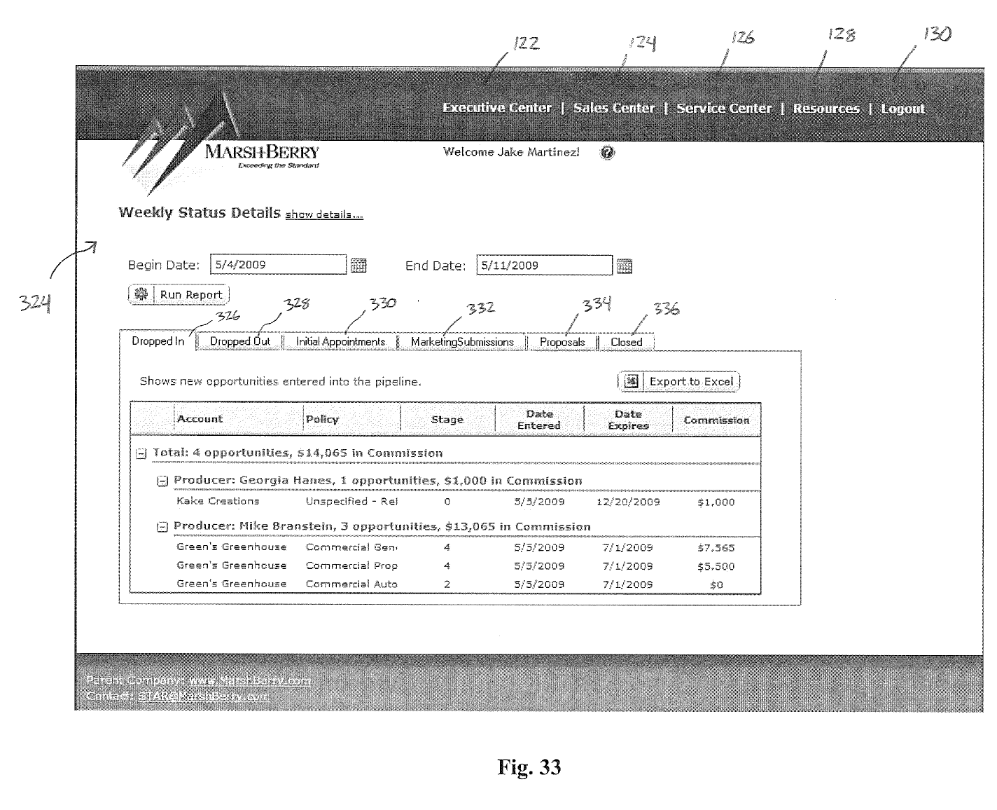

FIG. 33 illustrates a Weekly Status Details page 324 accessed by selecting Weekly Status Reports link 228 from within Executive Center menu 214. Weekly Status Details page 324 provides a snapshot of producer activity for a selected week. Weekly Status Details page 324 includes a Dropped In tab 326 providing access to a display of new opportunities that have entered into the pipeline for each producer, a Dropped Out tab 328 providing access to a display of lost opportunities (including walk-aways and expirations), an Initial Appointments tab 330 providing access to information on new initial appointment (stage 1) opportunities, a Marketing Submissions tab 332 providing access to information on new marketing (stage 2) opportunities, a Proposals tab 334 providing access to information on new proposal (stage 3) opportunities, and a Closed tab 336 providing information regarding closed opportunities for the selected week.

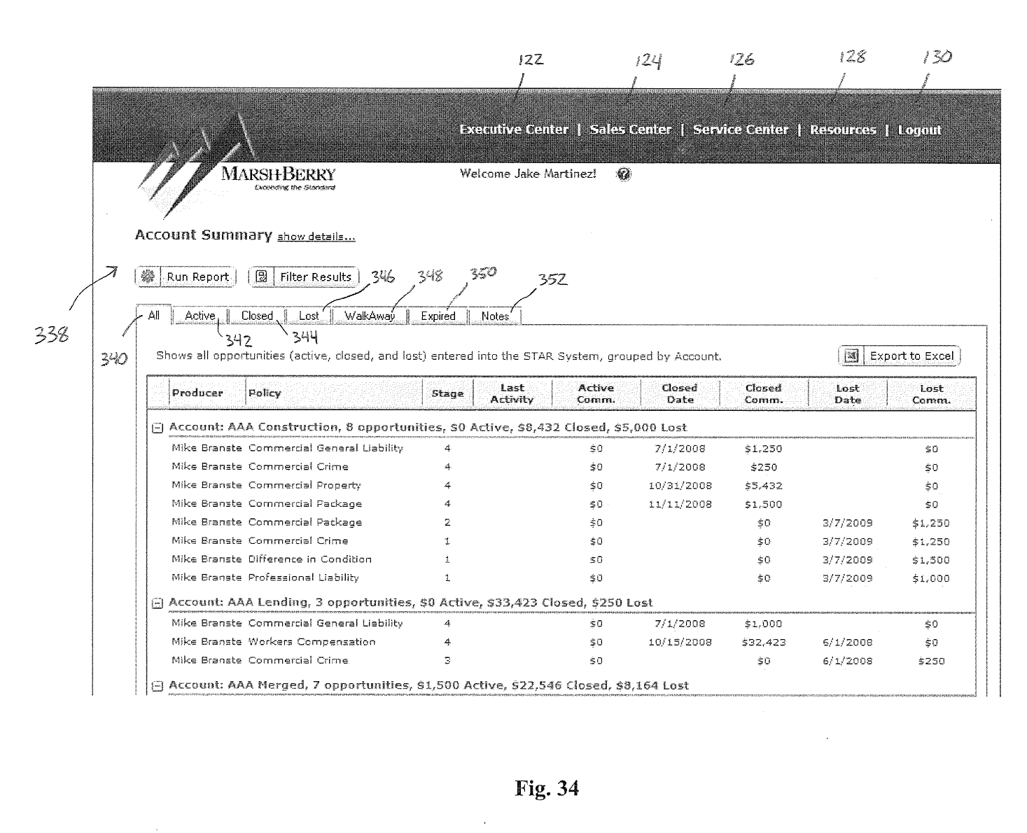

FIG. 34 illustrates an Account Summary page 338 accessed by selecting the Account Reports link 232 within Executive Center menu 214. Account summary page 338 allows agency management to quickly view all pipeline and lost account activity from within a single interface. Account Summary page 338 includes an All tab 340, showing all opportunities, including active, closed, and lost, that have been entered into system 100. An Active tab 342 displays all active opportunities currently within each producer's pipeline. A Closed tab 344 displays information regarding opportunities that have been closed by the agency's producers. A Lost tab 346 provides access to information regarding all lost opportunities, while a WalkAway tab 348, and Expired tab 350, provide access to more specific information regarding opportunities dropped by the producer, and by the client, respectively. Finally, a Notes tab 352 provides access to any note that agency producers have entered into their individual pipeline grids 142. Account Summary page 338 provides quick access to up-to-date information that is critical to driving organic growth within an agency.

Selecting Service Timeline Reports link 230 from within Executive Center menu 214 provide access to compliance and service level timeline reports, which are s discussed in detail in a concurrently filed application titled “Methods and Systems for Service Tracking and Timeline Updating”, the contents of which are incorporated by reference herein.

The methods and systems of the present invention, as described above and shown in the drawings, provide for an integrated, robust technology platform for tracking and 10 managing sales opportunities throughout the sales cycle to maximize productivity and facilitate organic growth within an organization. It will be apparent to those skilled in the art that various modifications and variations can be made to the systems and methods of the present invention without departing from the scope of the invention as outlined in the appended claims and their equivalents.

The invention claimed is:

1. A system for tracking and managing sales performance of producers within an insurance agency, the system comprising:
a database housing sales information for the agency;
a sales management server interfacing with the database;
a display device connected to the sales management server;
a user interface module running on the sales management server, the user interface module being configured to receive input from a user and to display content from the database on the display device;
an interactive sales pipeline module forming part of the user interface module, wherein the interactive sale pipeline module is configured to receive input from a user and store the information in the database and to display a grid of sales process information including information regarding an initial appointment stage, a marketing submission stage, and a proposal delivery stage.

2. The system of claim 1, further comprising a reports module interfacing with the database to produce reports based on the information entered into the interactive sales pipeline module.

3. The system of claim 2, wherein the reports module is configured to produce at least one of a commission summary report, an opportunity summary report, a ratios report, and a commission projection report.

4. The system of claim 2, wherein the reports module is configured to produce a validation report displaying the variance between a commission value earned by an individual producer associated with the agency and a predetermined validation standard.

5. The system of claim 4, wherein the user interface is configured to receive the predetermined validation standard from an executive user of the system.

6. The system of claim 4, wherein the sales management server is configured to interface with external devices through a network to receive up-to-date aggregated industry information to be used in determining the predetermined validation standard.

7. The system of claim 2, wherein the reports module is configured to produce a lost business report.

8. The system of claim 7, wherein the lost business report is a listing walk away opportunities.

9. The system of claim 7, wherein the lost business report is a listing of expired opportunities.

10. The system of claim 1, wherein the grid of sales process information displays the information grouped by account.

11. The system of claim 1, wherein the grid of sales process information displays the information grouped by an individual producer within the agency.

12. The system of claim 1, wherein the interactive sales pipeline module is configured to allow a user to edit the grid of sales process information directly within the grid.

13. The system of claim 1, wherein the grid of sales process information includes information regarding unrealized sales opportunities.

14. The system of claim 13, wherein the information shown in the grid includes the opportunity's line of business, the account type, the source of the opportunity, and the stage the opportunity is currently in.

15. The system of claim 13, wherein the information shown in the grid includes the expiration date of the opportunity, the estimated commission to be earned on the opportunity, the initial appointment date set for meeting with a prospective client to discuss the opportunity, the date that the opportunity was submitted to a marketing department within the agency, the number of carriers that the opportunity has been submitted to, and the date that the final proposal regarding the opportunity was delivered to the prospective client.

16. The system of claim 13, wherein the information shown in the grid includes the proposed commission based on a proposal submitted to a prospective client as well as the in-force commission existing for the prospective client.

17. A method for tracking and managing sales performance of producers within an insurance agency, the method comprising:
creating an opportunity account within a secure web-based interface;
populating a database with data regarding the opportunity account using an interactive sales pipeline module within the web-based interface;
displaying the data in the interactive sales pipeline module;
automatically generating an opportunity reports from the data entered into the interactive sales pipeline module in the web-based interface; and
allowing an authorized user to view the opportunity reports.

18. The method of claim 17, further comprising the step of allowing the authorized user to customize the opportunity reports.

19. The method of claim 17, wherein the opportunity reports include at least one of a closed business report, a pipeline report, a validation report, a lost business report, a carrier report, a referral report, a weekly status report, and an account report.

20. The method of claim 17, wherein the opportunity reports include a report of opportunities submitted to a carrier for receipt of a premium quote.
